(19) United States
(12) Patent Application Publication
(10) Pub. No.: US 2024/0340115 A1
(43) Pub. Date: Oct. 10, 2024

(54) SKIPPING INDICATION FOR A TIME WINDOW OF SCHEDULED RESOURCES

(71) Applicant: QUALCOMM Incorporated, San Diego, CA (US)

(72) Inventors: Ahmed ELSHAFIE, San Diego, CA (US); Peter GAAL, San Diego, CA (US); Huilin XU, Temecula, CA (US); Diana MAAMARI, San Diego, CA (US)

(21) Appl. No.: 18/296,632

(22) Filed: Apr. 6, 2023

(51) Int. Cl. H04L 1/1829; H04L 1/1812; H04W 72/1268

(52) U.S. Cl. CPC H04L 1/1854; H04L 1/1812; H04W 72/1268

(57) ABSTRACT

Methods, systems, and devices for wireless communication are described. The method may include a user equipment (UE) receiving a first control signal activating a first time window of scheduled resources that includes a set of uplink shared channel occasions. Further, the UE may allocate data to a first subset of the set of uplink shared channel occasions and transmit the data using the first subset. Moreover, the UE may transmit, after transmitting the data using the first subset of the set of uplink shared channel occasions, a second control signal indicating that a second subset of the set of uplink shared channel occasions will be skipped for uplink data transmission by the UE.

### FIELD OF TECHNOLOGY

The following relates to wireless communication, including a skipping indication for a time window of scheduled resources.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a UE may support configured scheduling. Using configured scheduling, the UE may perform uplink data transmissions to a network entity using periodically reoccurring resources (e.g., configured grant (CG) windows) without receiving explicit instructions (e.g., scheduling downlink control information (DCI)) from the network entity to do so for each transmission.

### SUMMARY

The described techniques relate to improved methods, systems, devices, and apparatuses that support a skipping indication for a time window of scheduled resources. In some examples, the method may include a user equipment (UE) receiving a first control message activating a first time window of scheduled resources that includes a set of uplink shared channel occasions. The UE may allocate data to a first subset of the set of uplink shared channel occasions and transmit the data using the first subset. After transmitting the data, the UE may transmit a second control message that indicates that a second subset of the set of uplink shared channel occasions will be skipped for data transmission by the UE. Upon reception of the second control message, the network entity may refrain from the decoding the second subset. Further, the UE may retransmit the data using a retransmission window that occurs after the first time window. In such example, the network entity may reallocate the unused uplink shared channel occasions of the retransmission window to another UE. The methods as described herein may allow a network entity to save power by deferring decoding of unused uplink shared channel occasions or increase system capacity by reallocating resources of unused uplink shared channel occasions to other UEs.

A method for wireless communication at a first UE is described. The method may include receiving a first control signal activating a set of pre-configured resources associated with a first time window, where the first time window includes a set of uplink shared channel occasions, allocating data to a first subset of the set of uplink shared channel occasions, transmitting the data using the first subset of the set of uplink shared channel occasions, and transmitting, after transmitting the data using the first subset of the set of uplink shared channel occasions, a second control signal indicating that a second subset of the set of uplink shared channel occasions will be skipped for uplink data transmission by the first UE.

An apparatus for wireless communication at a first UE is described. The apparatus may include a processor, memory coupled with the processor, and instructions stored in the memory. The instructions may be executable by the processor to cause the apparatus to receive a first control signal activating a set of pre-configured resources associated with a first time window, where the first time window includes a set of uplink shared channel occasions, allocate data to a first subset of the set of uplink shared channel occasions, transmit the data using the first subset of the set of uplink shared channel occasions, and transmit, after transmitting the data using the first subset of the set of uplink shared channel occasions, a second control signal indicating that a second subset of the set of uplink shared channel occasions will be skipped for uplink data transmission by the first UE.

Another apparatus for wireless communication at a first UE is described. The apparatus may include means for receiving a first control signal activating a set of pre-configured resources associated with a first time window, where the first time window includes a set of uplink shared channel occasions, means for allocating data to a first subset of the set of uplink shared channel occasions, means for transmitting the data using the first subset of the set of uplink shared channel occasions, and means for transmitting, after transmitting the data using the first subset of the set of uplink shared channel occasions, a second control signal indicating that a second subset of the set of uplink shared channel occasions will be skipped for uplink data transmission by the first UE.

A non-transitory computer-readable medium storing code for wireless communication at a first UE is described. The code may include instructions executable by a processor to receive a first control signal activating a set of pre-configured resources associated with a first time window, where the first time window includes a set of uplink shared channel occasions, allocate data to a first subset of the set of uplink shared channel occasions, transmit the data using the first subset of the set of uplink shared channel occasions, and transmit, after transmitting the data using the first subset of the set of uplink shared channel occasions, a second control signal indicating that a second subset of the set of uplink shared channel occasions will be skipped for uplink data transmission by the first UE.

In some examples of the method, apparatuses, and non-transitory computer-readable medium described herein, transmitting the second control signal may include operations, features, means, or instructions for transmitting, within a first timing offset, the second control signal, where the first timing offset may be measured from a temporally last uplink shared channel occasion of the set of uplink shared channel occasions, and where the first timing offset includes a minimum time for a network entity to skip decoding of the second subset of the set of uplink shared channel occasions.

In some examples of the method, apparatuses, and non-transitory computer-readable medium described herein, the first time window may be associated with a second time window that includes a first set of retransmission occasions and the method, apparatuses, and non-transitory computer-readable medium may include further operations, features, means, or instructions for allocating the data to a first subset of the first set of retransmission occasions and transmitting the data using the first subset of the first set of retransmission occasions.

In some examples of the method, apparatuses, and non-transitory computer-readable medium described herein, transmitting the second control signal may include operations, features, means, or instructions for transmitting, outside of a first timing offset and within a second timing offset, the second control signal, where the first timing offset may be measured from a temporally last uplink shared channel occasion of the set of uplink shared channel occasions and the first timing offset includes a minimum time for a network entity to skip decoding of the second subset of the set of uplink shared channel occasions, and where the second timing offset may be measured from the temporally last uplink shared channel occasion of the set of uplink shared channel occasions and the second timing offset includes a minimum time for the network entity to reallocate a second subset of the first set of retransmission occasions to a second UE.

In some examples of the method, apparatuses, and non-transitory computer-readable medium described herein, the second control signal further indicates that the second subset of the first set of retransmission occasions will be skipped for uplink data transmission by the first UE.

Some examples of the method, apparatuses, and non-transitory computer-readable medium described herein may further include operations, features, means, or instructions for receiving a first signal indicating the first timing offset, the second timing offset, or both.

Some examples of the method, apparatuses, and non-transitory computer-readable medium described herein may further include operations, features, means, or instructions for transmitting second data using a second subset of the first set of retransmission occasions.

In some examples of the method, apparatuses, and non-transitory computer-readable medium described herein, transmitting the second control signal may include operations, features, means, or instructions for transmitting the second control signal indicating that the second subset of the first set of retransmission occasions will be used for transmission of the second data.

Some examples of the method, apparatuses, and non-transitory computer-readable medium described herein may further include operations, features, means, or instructions for transmitting a third control signal indicating a hybrid automatic repeat request (HARQ) identifier (ID) associated with the second data.

In some examples of the method, apparatuses, and non-transitory computer-readable medium described herein, the first time window may be associated with a third time window that includes a second set of retransmission occasions and the method, apparatuses, and non-transitory computer-readable medium may include further operations, features, means, or instructions for allocating the data to a first subset of the second set of retransmission occasions and transmitting the data using the first subset of the second set of retransmission occasions.

In some examples of the method, apparatuses, and non-transitory computer-readable medium described herein, the second control signal further indicates one or both of a second subset of the first set of retransmission occasions or a second subset of the second set of retransmission occasions will be skipped for uplink transmission by the first UE.

In some examples of the method, apparatuses, and non-transitory computer-readable medium described herein, the second control signal indicates a bitmap including a set of bits, each bit of the set of bits corresponding to a respective uplink shared channel occasion of the set of uplink shared channel occasions, a respective retransmission occasion of the first set of retransmission occasions, or a respective retransmission occasion of the second set of retransmission occasions and a logic value of the bit indicates whether the respective uplink shared channel occasion of the set of uplink shared channel occasions, the respective retransmission occasion of the first set of retransmission occasions, or the respective retransmission occasion of the second set of retransmission occasions will be used for uplink data transmission by the first UE.

In some examples of the method, apparatuses, and non-transitory computer-readable medium described herein, transmitting the second control signal may include operations, features, means, or instructions for transmitting uplink control information (UCI), a medium access control control element (MAC-CE), radio resource control (RRC) signaling, a feedback message, a random access channel (RACH) message, a channel state information (CSI) message, a buffer status report (BSR) message, a PHR message, or a scheduling request (SR), the UCI, the MAC-CE, the RRC signaling, the feedback message, the RACH message, the CSI message, the BSR message, the PHR message, or the SR including the second control signal.

A method for wireless communication at a network entity is described. The method may include transmitting a first control signal activating a set of pre-configured resources associated with a first time window, where the first time window includes a set of uplink shared channel occasions, receiving, from a first UE, data using a first subset of the set of uplink shared channel occasions, and receiving, after receiving the data using the first subset of the set of uplink shared channel occasions, a second control signal indicating that a second subset of the set of uplink shared channel occasions will be skipped for uplink data transmission by the first UE.

An apparatus for wireless communication at a network entity is described. The apparatus may include a processor, memory coupled with the processor, and instructions stored in the memory. The instructions may be executable by the processor to cause the apparatus to transmit a first control signal activating a set of pre-configured resources associated with a first time window, where the first time window includes a set of uplink shared channel occasions, receive, from a first UE, data using a first subset of the set of uplink shared channel occasions, and receive, after receiving the data using the first subset of the set of uplink shared channel occasions, a second control signal indicating that a second subset of the set of uplink shared channel occasions will be skipped for uplink data transmission by the first UE.

Another apparatus for wireless communication at a network entity is described. The apparatus may include means for transmitting a first control signal activating a set of pre-configured resources associated with a first time window, where the first time window includes a set of uplink shared channel occasions, means for receiving, from a first UE, data using a first subset of the set of uplink shared channel occasions, and means for receiving, after receiving the data using the first subset of the set of uplink shared channel occasions, a second control signal indicating that a second subset of the set of uplink shared channel occasions will be skipped for uplink data transmission by the first UE.

A non-transitory computer-readable medium storing code for wireless communication at a network entity is described. The code may include instructions executable by a processor to transmit a first control signal activating a set of pre-configured resources associated with a first time window, where the first time window includes a set of uplink shared channel occasions, receive, from a first UE, data using a first subset of the set of uplink shared channel occasions, and receive, after receiving the data using the first subset of the set of uplink shared channel occasions, a second control signal indicating that a second subset of the set of uplink shared channel occasions will be skipped for uplink data transmission by the first UE.

Some examples of the method, apparatuses, and non-transitory computer-readable medium described herein may further include operations, features, means, or instructions for skipping decoding of the second subset of the set of uplink shared channel occasions based on receiving the second control signal within a first timing offset, the first timing offset measured from a temporally last uplink shared channel occasion of the set of uplink shared channel occasions and the first timing offset including a minimum time for the network entity to skip decoding of the second subset of the set of uplink shared channel occasions.

In some examples of the method, apparatuses, and non-transitory computer-readable medium described herein, the first time window may be associated with a second time window that includes a first set of retransmission occasions and the method, apparatuses, and non-transitory computer-readable medium may include further operations, features, means, or instructions for receiving the data using the first subset of the first set of retransmission occasions.

In some examples of the method, apparatuses, and non-transitory computer-readable medium described herein, receiving the second control signal may include operations, features, means, or instructions for reallocating a second subset of the first set of retransmission occasions to a second UE based on receiving the second control signal outside of a first timing offset and within a second timing offset, the first timing offset measured from a temporally last uplink shared channel occasion of the set of uplink shared channel occasions and the first timing offset including a minimum time for the network entity to skip decoding of the second subset of the set of uplink shared channel occasions, wherein the second timing offset is measured from the temporally last uplink shared channel occasion of the set of uplink shared channel occasions and the second timing offset includes a minimum time for the network entity to reallocate a second subset of the first set of retransmission occasions to a second UE.

In some examples of the method, apparatuses, and non-transitory computer-readable medium described herein, the second control signal further indicates that the second subset of the first set of retransmission occasions will be skipped for uplink data transmission by the first UE.

Some examples of the method, apparatuses, and non-transitory computer-readable medium described herein may further include operations, features, means, or instructions for transmitting a first signal indicating the first timing offset, the second timing offset, or both.

Some examples of the method, apparatuses, and non-transitory computer-readable medium described herein may further include operations, features, means, or instructions for receiving, from the first UE, second data using a second subset of the first set of retransmission occasions.

In some examples of the method, apparatuses, and non-transitory computer-readable medium described herein, receiving the second control signal may include operations, features, means, or instructions for receiving the second control signal indicating that the second subset of the first set of retransmission occasions will be used for transmission of the second data.

Some examples of the method, apparatuses, and non-transitory computer-readable medium described herein may further include operations, features, means, or instructions for receiving a third control signal indicating a HARQ ID associated with the second data.

In some examples of the method, apparatuses, and non-transitory computer-readable medium described herein, the first time window may be associated with a third time window that includes a second set of retransmission occasions and the method, apparatuses, and non-transitory computer-readable medium may include further operations, features, means, or instructions for receiving the data using the first subset of the second set of retransmission occasions.

In some examples of the method, apparatuses, and non-transitory computer-readable medium described herein, the second control signal further indicates one or both of a second subset of the first set of retransmission occasions or a second subset of the second set of retransmission occasions will be skipped for uplink transmission by the first UE.

In some examples of the method, apparatuses, and non-transitory computer-readable medium described herein, the second control signal indicates a bitmap including a set of bits, each bit of the set of bits corresponding to a respective uplink shared channel occasion of the set of uplink shared channel occasions, a respective retransmission occasion of the first set of retransmission occasions, or a respective retransmission occasion of the second set of retransmission occasions and a logic value of the bit indicates whether the respective uplink shared channel occasion of the set of uplink shared channel occasions, the respective retransmission occasion of the first set of retransmission occasions, or the respective retransmission occasion of the second set of retransmission occasions will be used for uplink data transmission by the first UE.

In some examples of the method, apparatuses, and non-transitory computer-readable medium described herein, receiving the second control signal may include operations, features, means, or instructions for receiving UCI, a MAC-CE, RRC signaling, a feedback message, a RACH message, a CSI message, a BSR message, a PHR message, or a SR, the UCI, the MAC-CE, the RRC signaling, the feedback message, the RACH message, the CSI message, the BSR message, the PHR message, or the SR including the second control signal.

### BRIEF DESCRIPTION OF THE DRAWINGS

FIGS. 1 and 2 show examples of a wireless communications system that supports a skipping indication for a time window of scheduled resources in accordance with one or more aspects of the present disclosure.

FIGS. 3 and 4 show examples of a physical uplink shared channel (PUSCH) skipping scheme that supports a skipping indication for a time window of scheduled resources in accordance with one or more aspects of the present disclosure.

FIG. 5 shows an example of a PUSCH skipping indication that supports skipping indication for a time window of scheduled resources in accordance with one or more aspects of the present disclosure.

FIG. 6 shows an example of a process flow that supports skipping indication for a time window of scheduled resources in accordance with one or more aspects of the present disclosure.

FIGS. 7 and 8 show block diagrams of devices that support skipping indication for a time window of scheduled resources in accordance with one or more aspects of the present disclosure.

FIG. 9 shows a block diagram of a communications manager that supports skipping indication for a time window of scheduled resources in accordance with one or more aspects of the present disclosure.

FIG. 10 shows a diagram of a system including a device that supports skipping indication for a time window of scheduled resources in accordance with one or more aspects of the present disclosure.

FIGS. 11 and 12 show block diagrams of devices that support skipping indication for a time window of scheduled resources in accordance with one or more aspects of the present disclosure.

FIG. 13 shows a block diagram of a communications manager that supports skipping indication for a time window of scheduled resources in accordance with one or more aspects of the present disclosure.

FIG. 14 shows a diagram of a system including a device that supports skipping indication for a time window of scheduled resources in accordance with one or more aspects of the present disclosure.

FIGS. 15 through 18 show flowcharts illustrating methods that support skipping indication for a time window of scheduled resources in accordance with one or more aspects of the present disclosure.

### DETAILED DESCRIPTION

In some examples, a user equipment (UE) may receive a control signal activating a set of time and frequency resources for communication. In some examples, the control signal may be referred to as a configured grant (CG). The CG may correspond to a CG window that may include multiple physical uplink shared channel (PUSCH) occasions. In some examples, the UE may not have enough data for some of the PUSCH occasions and as such, the UE may allocate data to a portion of the PUSCH occasions, leaving one or more of the PUSCH occasions unused. To not waste the resources occupied by the unused PUSCH occasion, the UE may send an indication of the unused PUSCH occasions to a network entity such that the network entity may reallocate resources of the unused PUSCH occasions to other UEs. In some examples, the UE may send this indication at least a configured time period prior to transmitting over the PUSCH occasions of the CG period. The time period may be the minimum time needed for the network entity to process the indication and reallocate the resources of the unused PUSCH occasions to other UEs. If the UE sends the indication too late (e.g., inside of the configured time period), the network entity may be unable to reallocate the resources.

However, even if the indication of the unused PUSCH occasions is transmitted late, the network entity may be able to use the indication for other operations other than the reallocation of the unused resources. For example, after transmitting over the PUSCH occasions of the CG period, the network entity may take some time to process the PUSCHs. If the UE transmits the indication of the unused PUSCH occasions prior to the end of the processing time, the network entity may utilize the indication to skip decoding of (or attempting to decode) the unused PUSCH occasions. In another example, the UE may be enabled with a retransmission mode. If retransmission mode is enabled, after the initial CG window, the UE may be allocated with one or more retransmission windows that include multiple PUSCH occasions for the purpose of retransmitting the PUSCHs. In such example, the indication may be sent prior to or after the processing time and the network entity may utilize this indication to reallocate unused PUSCH occasions in the retransmission periods to other UEs.

Aspects of the disclosure are initially described in the context of wireless communications systems. Additional aspects of the disclosure are described in the context of a PUSCH skipping scheme, a PUSCH skipping indication, and a process flow. Aspects of the disclosure are further illustrated by and described with reference to apparatus diagrams, system diagrams, and flowcharts that relate to skipping indication for a time window of scheduled resources.

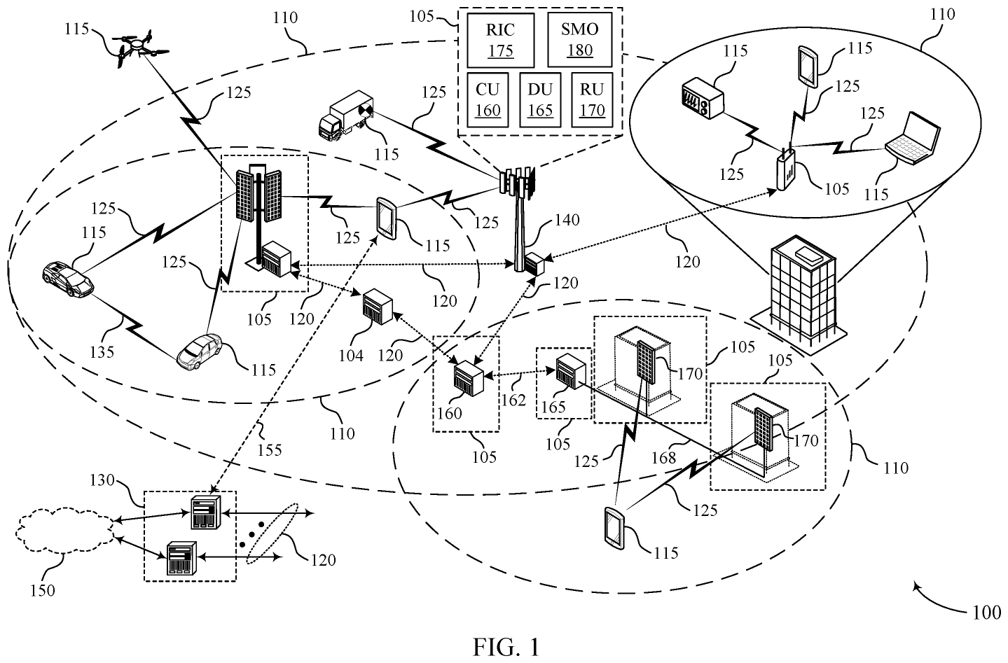

FIG. 1 shows an example of a wireless communications system 100 that supports skipping indication for a time window of scheduled resources in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support skipping indication for a time window of scheduled resources as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, the UE 115 may support a skipping indication for a time window of scheduled resources. In some examples, the UE 115 may receive a first control message activating a first time window of scheduled resources that includes a set of uplink shared channel occasions. The UE 115 may allocate data to a first subset of the set of uplink shared channel occasions and transmit the data using the first subset. After transmitting the data, the UE 115 may transmit a second control message that indicates that a second subset of the set of uplink shared channel occasions will be skipped for data transmission by the UE 115. Upon reception of the second control message, the network entity 105 may refrain from the decoding the second subset. Further, the UE 115 may retransmit the data using a retransmission window that occurs after the first time window. In such example, the network entity 105 may reallocate the unused uplink shared channel occasions of the retransmission window to another UE 115. The methods as described herein may allow a network entity 105 to save power by deferring decoding of unused uplink shared channel occasions or increase system capacity by reallocating resources of unused uplink shared channel occasions to other UEs 115.

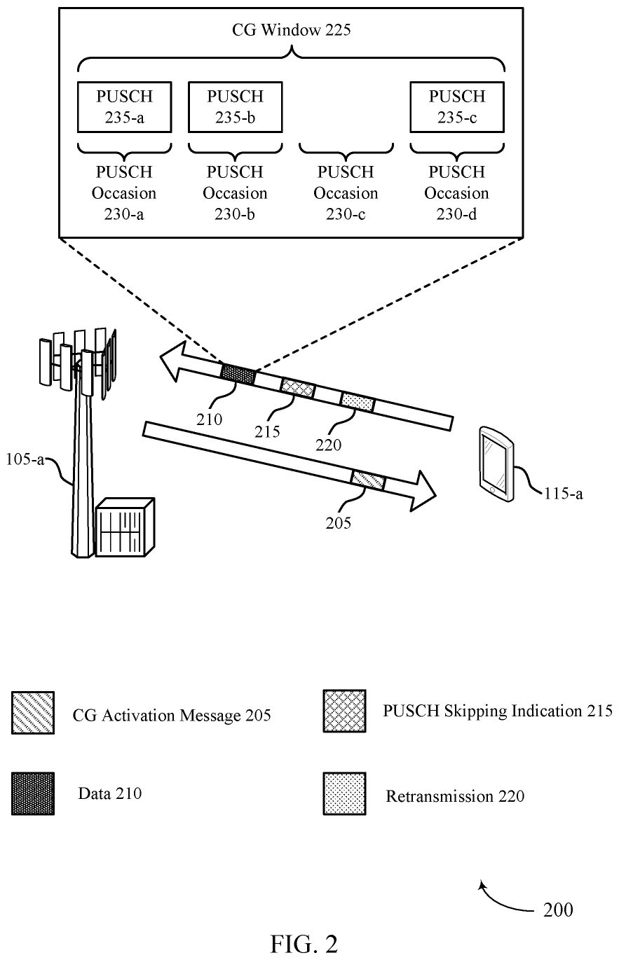

FIG. 2 shows an example of a wireless communications system 200 that supports a skipping indication for a time window of scheduled resources in accordance with one or more aspects of the present disclosure. In some examples, the wireless communications system 200 may implement aspects of a wireless communications system 100. For example, the wireless communications system 200 may include a UE 115-a and a network entity 105-a, which may be examples of a UE 115 and a network entity 105 as described with reference to FIG. 1, respectively.

In some examples, the network entity 105-a may establish a communication link with the UE 115-a. Data may arrive at the UE 115-a and the UE 115-a may transmit the data to network entity 105-a using the communication link. Data transmissions from the UE 115-a to the network entity 105-a may be known as uplink transmissions. The network entity 105-a may schedule the UE 115-a for uplink transmissions using dynamic scheduling or configured scheduling. Configured scheduling may allow the UE 115-a to allocate resources for an uplink transmission without receiving a scheduling DCI or a DCI scheduling the uplink transmission.

To support configured scheduling, the UE 115-a may receive a control message (e.g., an RRC message) that includes information associated with configured scheduling. As one example, the control message may include a CG configuration. The CG configuration may indicate a periodically reoccurring time window (e.g., a CG window 225) over which the UE 115-a may transmit uplink transmissions. In some examples, the CG window 225 may include multiple PUSCH occasions 230 (e.g., a PUSCH occasion 230-a, a PUSCH occasion 230-b, a PUSCH occasion 230-c, and a PUSCH occasion 230-d) for transmitting multiple PUSCHs 235 (e.g., multiple sets of one or two transport block (TBs)). In such examples, the CG configuration may include a first field that indicates a number of consecutive PUSCHs 235 within a slot (e.g., cg-nrofPUSCH-InSlot). The temporally first PUSCH 235 of the multiple PUSCHs 235 may follow the start and length indicator value (SLIV) provided via the control message or a different message and each of the following PUSCHs 235 may have a same length and may be appended following the previous allocation without any gaps.

In some examples, the UE 115-a may perform one or more retransmissions or repetitions of the PUSCHs 235 of the CG window 225. In such example, the CG configuration may also include information associated with one or more retransmission windows for retransmitting the PUSCHs 235 of the CG window 225. For example, the CG configuration may include one or more of a second field that indicates a number of consecutive slots allocated within a CG period (e.g., cg-nrofSlots), a third field that indicates the number of retransmission windows or repetitions (e.g., repK), a fourth field that indicates a redundancy version (RV) for the one or more retransmission windows (e.g., repK-RV), or a fifth field that indicates a value of a retransmission timer (e.g., cg-retransmission timer). The retransmission timer may initiate after the CG window 225 and upon expiration of the retransmission timer, the retransmission window may begin.

If the UE 115-a is configured to perform multiple retransmissions, the retransmission timer may additionally initiate after the retransmission window and upon expiration of the retransmission timer, another retransmission window may begin. The value of the retransmission timer may be less than a value for a CG timer and in some examples, the fifth field may be configured for operation with shared spectrum channel together with HARQ process ID offset. In some examples, the UE 115-a may activate the CG configuration upon receiving the first control message (e.g., the RRC message). In another example, the UE 115-a may receive a second control message (e.g., activation DCI) from the network entity 105-a indicating activation of the CG configuration.

In some examples, data may arrive at the UE 115-a and the UE 115-a may allocate the data to all of the PUSCH occasions 230 of the CG window 225. Alternatively, the UE 115-a may receive less data or receive a portion of the data late. In such case, the UE 115-a may be unable to allocate the data to all of the PUSCH occasions 230. For example, the UE 115-a may allocate data to the PUSCH occasion 230-a, the PUSCH occasions 230-b, and the PUSCH occasion 230-d of the CG window 225, leaving the PUSCH occasion 230-c unused. If the UE 115-a is unable to utilize all of the PUSCH occasions 230, the UE 115-a may transmit a message to the network entity 105-a indicating that the PUSCH occasion 230-c is unused such that the network entity 105-a may reallocate resources associated with the PUSCH occasion 230-c to a different UE 115 (e.g., different from the UE 115-a).

In some examples, the UE 115-a may transmit the message to the network entity 105-a prior to transmitting the PUSCHs 235 during the CG window 225. Specifically, the UE 115-a may transmit the message to the network entity 105-a at least K before the UE 115-a transmits the temporally first PUSCH 235 of the CG window 225 (e.g., the PUSCH 235-a). K may represent a minimum time for the network entity 105-a to process the message and reallocate the resources of the unused PUSCH occasion 230 to another UE 115. If the UE 115-a is unable to transmit the message such that K is satisfied, the UE 115-a may not transmit the message. However, the message indicating the unused PUSCH occasion 230 may still be helpful to the network entity 105-a, even if K is not satisfied.

In some examples, the UE 115-a may receive a CG activation message 205 (e.g., an RRC message or an activation DCI) activating the CG configuration. The CG configuration may correspond to the CG window 225 that includes a set of PUSCH occasions 230 (e.g., the PUSCH occasion 230-a, the PUSCH occasion 230-b, the PUSCH occasion 230-c, and the PUSCH occasion 230-d) and in some examples, the CG configuration may correspond to one or more retransmission windows. In some examples, data 210 may arrive at the UE 115-a and the UE 115-a may allocate the data 210 (e.g., the PUSCH 235-a, the PUSCH 235-b, and the PUSCH 235-d) to the PUSCH occasion 230-a, the PUSCH occasion 230-b, and the PUSCH occasion 230-d, leaving the PUSCH occasion 230-c unused. The UE 115-a may then transmit the data 210 over the corresponding PUSCH occasions 230.

Upon receiving the data 210, the network entity 105-a may attempt to process and decode the data 210. The minimum time for the network entity 105-a to process and decode the data 210 after receiving the data 210 may be known as T_{proc} (or T_PUSCH_proc). In some examples, the network entity 105-a may transmit a signal to the UE 115-a indicating T_{proc}. The units of T_{proc} may be OFDM symbols or slots which may depend on a numerology (or subcarrier spacing (SCS)) supported by the UE 115-a.

After transmitting the data 210 over the corresponding PUSCH occasions 230, the UE 115-a may transmit a PUSCH skipping indication 215. The PUSCH skipping indication 215 may indicate that the PUSCH occasion 230-c is unused. In some examples, the UE 115-a may transmit the PUSCH skipping indication 215 to the network entity 105-a within T_{proc} or prior to the end of T_{proc}. In such example, the network entity 105-a may leverage the PUSCH skipping indication 215 to refrain from decoding the skipped PUSCH occasion 230 (e.g., the PUSCH occasion 230-c) and in some examples, if retransmission is configured, the network entity 105-a may refrain from decoding the corresponding skipped PUSCH occasions 230 in the subsequent one or more retransmission windows.

In another example, the UE 115-a may transmit the PUSCH skipping indication 215 after T_{proc}. In such case, the network entity 105-a may utilize the skipping indication to reallocate resources of the corresponding skipped PUSCH occasions 230 of the subsequent one or more retransmission windows to another UE 115. Further, in such case, the UE 115-a may transmit the PUSCH skipping indication 215 to the network entity 105-a at least T_{allocate} before the UE 115-a transmits the temporally first PUSCH 235 of the retransmission window. T_{allocate} may represent the minimum time for the network entity 105-a to process the PUSCH skipping indication 215 and reallocate the resources of the unused PUSCH occasion of the one or more retransmission windows to another UE 115. Upon transmitting the PUSCH skipping indication 215, the UE 115-a may perform retransmission 220 during the retransmission window. That is, the UE may transmit the data over a portion of the PUSCH occasions of the retransmission window (e.g., PUSCH occasions corresponding to the PUSCH occasion 230-a, the PUSCH occasion 230-b, and the PUSCH occasion 230-d of the CG window 225).

In another example, the UE 115-a may utilize the unused PUSCH occasions included in the one or more retransmission windows (e.g., PUSCH occasions corresponding to the PUSCH occasion 230-c of the CG window 225) to transmit new data (e.g., data that may arrive after data 210 that the UE 115-a was unable to allocate to the CG window 225). In such example, the PUSCH skipping indication 215 may include an indication that the UE 115-a will utilize the unused PUSCH occasions included in the one or more retransmission windows to transmit new data. Further, in such example, the UE 115-a may provide the network entity 105-a with a HARQ ID associated with the new data. The HARQ ID may be included in the PUSCH skipping indication 215 or in a separate message.

In some examples, L1, L2, or L3 signaling may be used to transmit the PUSCH skipping indication 215. For example, the UE 115-a may include PUSCH skipping indication in uplink control information (UCI) (e.g., CG-UCI or a new UCI), a medium access control control element (MAC-CE), or an RRC message (e.g., user-assistance information in the RRC message). Alternatively, the UE 115-a may multiplex the PUSCH skipping indication 215 with different message. For example, the UE 115-a may multiplex the PUSCH skipping indication 215 with a channel state information (CSI) message, a buffer status report (BSR) message, a scheduling request (SR) message, a power headroom report (PHR) message, random access channel (RACH) message, or a feedback message (e.g., an acknowledgement (ACK) message). Using the method as described herein, the UE 115-c may indicate unused resource of a CG window 225 or associated retransmission windows which may allow the network entity 105-a to allocate these unused resources to other UEs 115 or defer decoding of the unused resources which may increase system capacity and reduce processing latency.

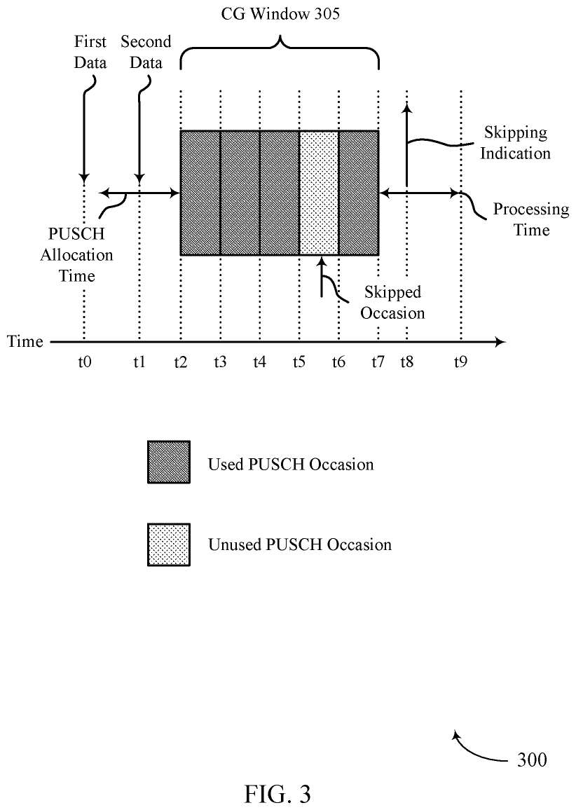

FIG. 3 shows an example of a PUSCH skipping scheme 300 that supports a skipping indication for a time window of scheduled resources in accordance with one or more aspects of the present disclosure. In some examples, the PUSCH skipping scheme 300 may be implemented by aspects of a wireless communications system 100 and a wireless communications system 200. For example, the PUSCH skipping scheme 300 may be implemented by a UE 115 and a network entity 105 as described with reference to FIGS. 1 and 2.

As described with reference to FIG. 2, a UE may support configured scheduling and may communicate uplink data to a network entity using a CG window 305 that includes multiple PUSCH occasions. At t0, first data may arrive at the UE and the UE may allocate the first data to a first portion of the PUSCH occasions of the CG window 305. Further, at t1, second data may arrive at the UE. However, the UE may be unable to the allocate the second data to a second portion of the PUSCH occasions of the CG window 305 because the second data may arrive at the UE after the PUSCH allocation time. The PUSCH allocation time may represent the minimum amount of time that the UE needs to allocate the second data to the CG window 305. Thus, the second portion of the PUSCH occasions of the CG window 305 may be unused.

The CG window 305 may start at t2 and end at t7. From t2 to t3 (e.g., during a first PUSCH occasion of the CG window 305), the UE may transmit a first portion of the first data (e.g., a first PUSCH) to the network entity. From t3 to t4 (e.g., during a second PUSCH occasion of the CG window 305), the UE may transmit a second portion of the first data (e.g., a second PUSCH) to the network entity. From t4 to t5 (e.g., during a third PUSCH occasion of the CG window 305), the UE may transmit a third portion of the first data (e.g., a third PUSCH) to the network entity. From t5 to t6 (e.g., during a fourth PUSCH occasion of the CG window 305), the UE may not transmit data and as such, the UE may skip the fourth PUSCH occasion. From t6 to t7 (e.g., during a fifth PUSCH occasion of the CG window 305), the UE may transmit a fourth portion of the first data (e.g., a fourth PUSCH) to the network entity.

After the CG window 305 and at t8, the UE may transmit a skipping indication to the network entity. The skipping indication may indicate that the fourth PUSCH occasion of the CG window 305 is unused. In some examples, the UE may transmit the skipping indication to the network entity during a processing time of the network entity. The processing time may last from t7 to 19 and may represent a minimum amount of time that the network entity needs to process the CG window 305 (e.g., process the first data received from the UE). In response to receiving the skipping indication, the network entity may skip decoding of the skipped PUSCH occasion of the CG window 305 (e.g., the fourth PUSCH occasion). Skipping decoding of the skipped PUSCH occasion may allow the network entity to reduce power consumption related to processing the first data and also, decrease latency related to processing the first data.

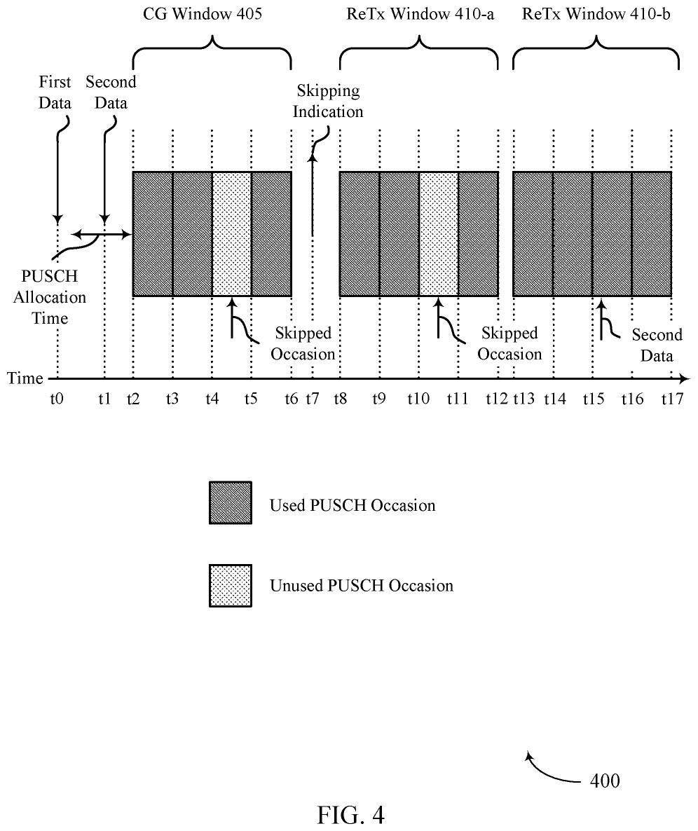

FIG. 4 shows an example of a PUSCH skipping scheme 400 that supports a skipping indication for a time window of scheduled resources in accordance with one or more aspects of the present disclosure. In some examples, the PUSCH skipping scheme 400 may be implemented by aspects of a wireless communications system 100 and a wireless communications system 200. For example, the PUSCH skipping scheme 400 may be implemented by a UE 115 and a network entity 105 as described with reference to FIGS. 1 and 2.

As described with reference to FIG. 2, a UE may support configured scheduling and may communicate uplink data to a network entity using a CG window 405 that includes multiple PUSCH occasions. Further, the UE may retransmit the uplink data over one or more retransmission windows 410 that may occur after the CG window 405. At t0, first data may arrive at the UE and the UE may allocate the first data to a first portion of the PUSCH occasions of the CG window 405. Further, at t1, second data may arrive at the UE. However, the UE may be unable to the allocate the second data to a second portion of the PUSCH occasions of the CG window 405 because the second data may arrive after a PUSCH allocation time. The PUSCH allocation time may represent a minimum amount of time that the UE needs to allocate the second data to the CG window 405. Thus, the second portion of the PUSCH occasions of the CG window 405 may be unused.

The CG window 405 may start at t2 and end at t6. From t2 to t3 (e.g., during a first PUSCH occasion of the CG window 405), the UE may transmit a first portion of the first data (e.g., a first PUSCH) to the network entity. From t3 to t4 (e.g., during a second PUSCH occasion of the CG window 405), the UE may transmit a second portion of the first data (e.g., a second PUSCH) to the network entity. From t4 to t5 (e.g., during a third PUSCH occasion of the CG window 405), the UE may not transmit data and as such, the UE may skip the third PUSCH occasion. From t5 to t6 (e.g., during a fourth PUSCH occasion of the CG window 405), the UE may transmit a third portion of the first data (e.g., a third PUSCH) to the network entity.

After the CG window 405 and at t7, the UE may transmit a skipping indication to the network entity. The skipping indication may indicate that the third PUSCH occasion of the CG window 405 is unused. Further, the skipping indication may indicate that PUSCH occasions of one or more subsequent retransmission windows 410 (e.g., all or a subset) corresponding to the third PUSCH occasion of CG window 405 may also be unused. In some examples, the UE may transmit the skipping indication to the network entity prior to a PUSCH reallocation time. The PUSCH reallocation time may last from t7 to t8 and may represent a minimum amount of time that the network entity needs to reallocate a skipped PUSCH occasion of a retransmission window 410-a to another UE. In response to receiving the skipping indication, the network entity may reallocate the skipped PUSCH occasions of at least one retransmission window 410 (e.g., the retransmission window 410-a) to another UE.

The retransmission window 410-a may start at t8 and end at t12. From t8 to t9 (e.g., during a first PUSCH occasion of the retransmission window 410-a), the UE may transmit the first portion of the first data (e.g., the first PUSCH) to the network entity. From t9 to t10 (e.g., during a second PUSCH occasion of the retransmission window 410-a), the UE may transmit the second portion of the first data (e.g., the second PUSCH) to the network entity. From t10 to t11 (e.g., during a third PUSCH occasion of the retransmission window 410-a), the UE may not transmit data. Instead, the resources of the third PUSCH occasion of the retransmission window 410-a may be allocated to a different UE. From t11 to t12 (e.g., during a fourth PUSCH occasion of the retransmission window 410-a), the UE may transmit the third portion of the first data (e.g., the third PUSCH) to the network entity. Reallocating the resources of the third PUSCH occasion of the retransmission window 410-a may increase system capacity.

In another example, the UE may utilize the unused or skipped PUSCH occasions of at least one of the retransmission windows 410 to transmit the second data to the network entity. For example, the UE may utilize the unused PUSCH occasion of the retransmission window 410-b to transmit the second data. In such example, the skipping indication may include an indication that the unused or skipped PUSCH occasions of at least one of the retransmission windows 410 (e.g., a third PUSCH occasion of the retransmission window 410-b) will be used to transmit the second data. Further, the UE may provide a HARQ ID associated with the second data the network entity. In some examples, the HARQ process ID may be included in CG-UCI.

The retransmission window 410-b may start at t13 and end at t17. From t13 to t14 (e.g., during a first PUSCH occasion of the retransmission window 410-b), the UE may transmit the first portion of the first data (e.g., the first PUSCH) to the network entity. From t14 to t15 (e.g., during a second PUSCH occasion of the retransmission window 410-b), the UE may transmit the second portion of the first data (e.g., the second PUSCH) to the network entity. From t15 to t16 (e.g., during the third PUSCH occasion of the retransmission window 410-b), the UE may transmit the second data to the network entity. From t16 to t17 (e.g., during the fourth PUSCH occasion of the retransmission window 410-b), the UE may transmit the third portion of the first data (e.g., the third PUSCH) to the network entity.

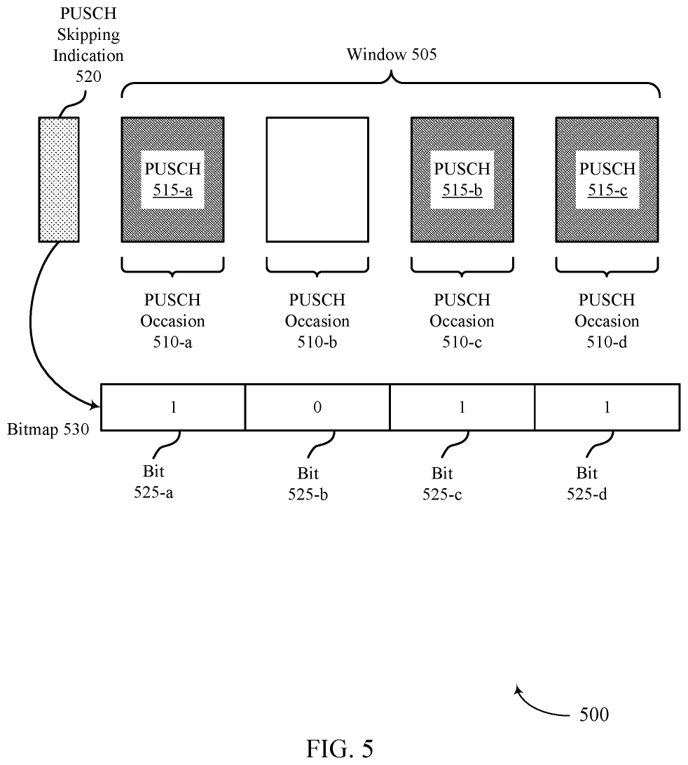

FIG. 5 shows an example of a PUSCH skipping indication 500 that supports a skipping indication for a time window of scheduled resources in accordance with one or more aspects of the present disclosure. In some examples, the PUSCH skipping indication 500 may be implemented by aspects of a wireless communications system 100 and a wireless communications system 200. For example, the PUSCH skipping indication 500 may be implemented by a UE 115 and a network entity 105 as described with reference to FIGS. 1 and 2.

As described with reference to FIG. 2, a UE may support dynamic scheduling. In dynamic scheduling, the UE may transmit data to a network entity using periodically occurring CG windows. Each CG window may include a set of PUSCH occasions and during each PUSCH occasion, the UE may transmit a portion of the data (e.g., one or two TBs). Further, in some examples, after each CG window, the UE may retransmit the data during one or more retransmission windows. Similar to the CG window, the one or more retransmission windows may include a set of PUSCH occasions, and during each PUSCH occasion, the UE may retransmit the portion of the data. In the example of FIG. 5, the window 505 may be an example of a CG window or a retransmission window.

In some examples, the UE 115 may utilize only a portion of the PUSCH occasions 510 of the window 505. For example, the UE may transmit a first portion of the data (e.g., PUSCH 515-a) using the PUSCH occasion 510-a, a second portion of the data (e.g., a PUSCH 515-b) using the PUSCH occasion 510-c, and a third portion of the data (e.g., a PUSCH 515-c) using the PUSCH occasion 510-d leaving the PUSCH occasion 510-b unused.

Upon determining that the PUSCH occasion 510-b is unused, the UE may transmit a PUSCH skipping indication 520 to the network entity. The PUSCH skipping indication 520 may inform the network entity of which PUSCH occasions 510 of the window 505 may be unused. In some examples, the PUSCH skipping indication 520 may be applicable to the CG window, the one or more retransmission windows, or both. Further, the UE may transmit the PUSCH skipping indication 520 to the network entity prior to the CG window or after the CG window (and prior to the temporally first retransmission window). In some examples, resources for the PUSCH skipping indication 520 may be configured as periodic, aperiodic, or dynamically.

In some examples, the PUSCH skipping indication 520 may include an indication of a bitmap 530. The bitmap 530 may include a set of bits and each bit of the set of bits may correspond to a PUSCH occasion 510 of the window 505. For example, the PUSCH occasion 510-a may correspond to the bit 525-a, the PUSCH occasion 510-b may corresponds to the bit 525-b, the PUSCH occasion 510-c may correspond to the bit 525-e, and the PUSCH occasion 510-d may correspond to the bit 525-d. Further, a logic value of the bit 525 may indicate whether or not the corresponding PUSCH occasion 510 is or will be utilized by the UE. For example, a logic value of 1 may indicate that the corresponding PUSCH occasion 510 is being used and a logic value of 0 may indicate that the corresponding PUSCH occasion 510 is not being used.

In the example of FIG. 5, the bit 525-a may have a logic value of 1, the bit 525-b may have a logic value of 0, the bit 525-c may have a logic value of 1, and the bit 525-d may have a logic value of 1 which may indicate that the PUSCH occasion 510-a, the PUSCH occasion 510-c, and the PUSCH occasion 510-d will be used by the UE to transmit uplink data and the PUSCH occasion 510-c will not be used by the UE to transmit uplink data. The PUSCH skipping indication 520 may include the bitmap 530 or the PUSCH skipping indication 520 may include a codepoint pointing to the bitmap 530.

In another example, the PUSCH skipping indication 520 may include a codepoint that indicates the unused PUSCH occasion 510. As one example, the codepoint may indicate the index of the unused PUSCH occasion 510 (e.g., the temporally first unused PUSCH occasion). Alternatively, the codepoint may indicate an entry of table that includes a pattern for unused PUSCH occasions 510 (e.g., similar to a time domain resource allocation (TDRA) table). Alternatively, the codepoint may indicate a SLIV corresponding to the one or more skipped PUSCH occasion 510 (e.g., a start occasion and a number of skipped PUSCH occasions 510). As another option, the PUSCH skipping indication 520 may indicate to skip all PUSCH occasions 510 or a subset of PUSCH occasions 510 of the window 505 (e.g., using a first level bitmap). If the PUSCH skipping indication 520 does not indicate to skip all PUSCH occasions of the window 505, the network entity may determine which PUSCH occasions are skipped (e.g., using a second level bit map).

In some examples, the payload size of the PUSCH skipping indication 520 may depend on a number of retransmission windows configured for the UE. For example, the bits included in the bitmap 530 of FIG. 5 may increase by four for each added retransmission window. The UE may implicitly determine the payload size of the PUSCH skipping indication 520 using the number of configured retransmission windows or the network entity may transmit signaling to the UE indicating the payload size of the PUSCH skipping indication 520 (e.g., via L1/L2/L3 signaling).

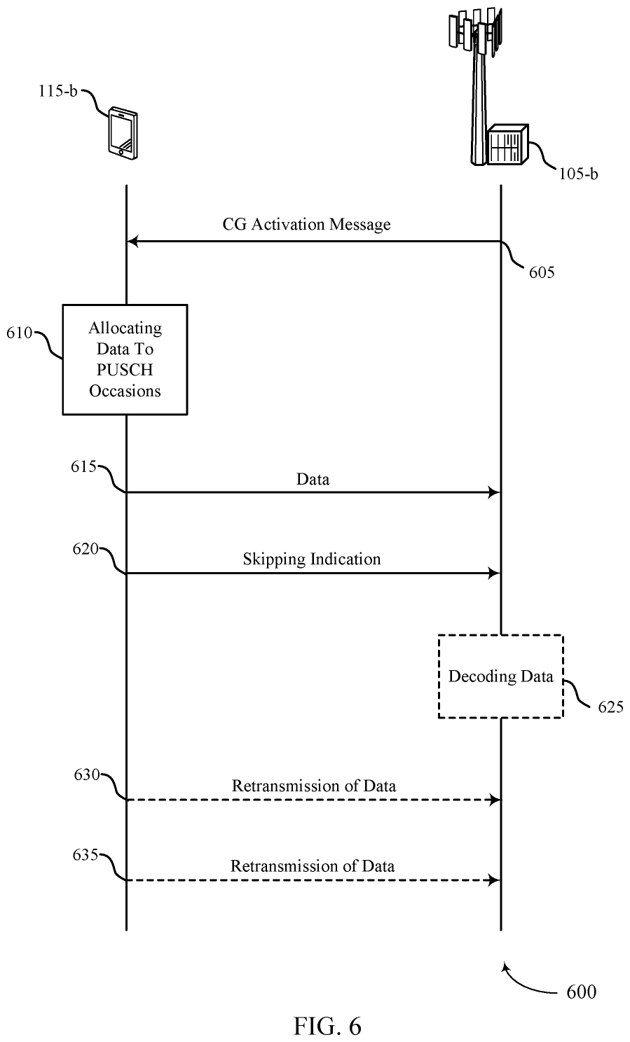

FIG. 6 shows an example of a process flow 600 that supports a skipping indication for a time window of scheduled resources in accordance with one or more aspects of the present disclosure. In some examples, the process flow 600 may be implemented by aspects of a wireless communications system 100 and a wireless communications system 200. For example, the process flow 600 may be implemented by a UE 115-b and a network entity 105-b which may be examples of a UE 115 and a network entity 105 as described with reference to FIGS. 1 and 2, respectively. Alternative examples of the following may be implemented, where some steps are performed in a different order than described or are not performed at all. In some cases, steps may include additional features not mentioned below, or further steps may be added.

At 605, the network entity 105-b may transmit a CG activation message to the UE 115-b. The CG activation message may activate a first time window (e.g., a CG time window) of scheduled resources that includes a set of uplink shared channel occasions (e.g., a set of PUSCH occasions).

At 610, the UE 115-b may allocate data to a first subset of the set of uplink shared channel occasions. A second subset of the set of uplink shared channel occasions may be skipped (e.g., the UE 115-b may not allocate any of the data to the second subset of the set of uplink shared channel occasions).

At 615, the UE 115-b may transmit the data using the first subset of the set of uplink shared channel occasions.

At 620, the UE 115-b may transmit, after transmitting the data, a skipping indication message indicating that the second subset of the set of uplink shared channel occasions will be skipped for uplink transmission by the UE 115-b. In some examples, the UE 115-b may transmit the skipping indication message to the network entity 105-b within a first timing offset. The first timing offset may be measured from a temporally last uplink shared channel occasion of the set of uplink shared channel occasions. Further, the first timing offset may include a minimum time for the network entity 105-b to skip decoding of the second subset of the set of uplink shared channel occasions.

In another example, the UE 115-b may transmit the skipping indication message to the network entity 105-b outside of the first timing offset and within a second timing offset. The second timing offset may be measured from the temporally last uplink shared channel occasion of the set of uplink shared channel occasions. Further, the second timing offset may include a minimum time for the network entity 105-b to reallocate resources of an unused retransmission occasion of a second time window (e.g., a retransmission window associated with the first time window) to a second UE 115 (e.g., different from the UE 115-b). In some examples, the network entity 105-b may transmit signaling to the UE 115-b indicating the first timing offset and the second timing offset. In some examples, upon receiving the PUSCH skipping indication at 620, the network entity 105-b may reallocate the unused retransmission opportunities of the second time window to a second UE.

In some examples, the PUSCH skipping indication message may be included in UCI, a MAC-CE, RRC signaling, a feedback message, a RACH message, a CSI message, a BSR message, or an SR message. Further, in some examples, the PUSCH skipping indication message may include a bitmap. Each bit may correspond to a respective shared channel occasion or a respective retransmission occasion and a logic value of the bit may indicate whether the respective shared channel occasion or the respective retransmission occasion will be used for uplink transmission by the UE 115-b.

At 625, the network entity 105-b may decode the data received at 615. In some examples, the network entity 105-b may skip decoding of the second subset of the set of uplink shared channel occasions (e.g., as a result of receiving the PUSCH skipping indication message at 620).

At 630, the UE 115-b may retransmit the data using the second time window that includes a first set of retransmission occasions. The UE 115-b may allocate the data to a first subset of the first set of retransmission occasions and transmit the data over the first subset of the first set of retransmission occasions. The second subset of the first set of retransmission occasions may be unused and as such, the PUSCH skipping indication message may also indicate that a second subset of the first set of retransmission occasions will be skipped for uplink data transmission by the UE 115-b. Further, as described above, the network entity 105-b may reallocate the resource of the second subset of the first set of retransmission occasions to a second UE (e.g., based on the receiving the skipping indication at 620).

In another example, the UE 115-b may utilize the second subset of the first set of retransmission occasions to transmit new data (e.g., second data) to the network entity 105-b. In such example, the PUSCH skipping indication may, additionally or alternatively, include an indication that the second subset of the first set of retransmission occasions will be used for transmission of the new data. Further, the PUSCH skipping indication may further include a HARQ ID associated with the new data.

At 635, the UE 115-b may retransmit the data using a third time window (e.g., a retransmission time window) that includes a second set of retransmission occasions. The UE 115-b may allocate the data to a first subset of the second set of retransmission occasions and transmit the data over the first subset of the second set of retransmission occasions. In such example, the PUSCH skipping indication message may also indicate that a second subset of the second set of retransmission occasions will be skipped for uplink data transmission by the UE 115-b.

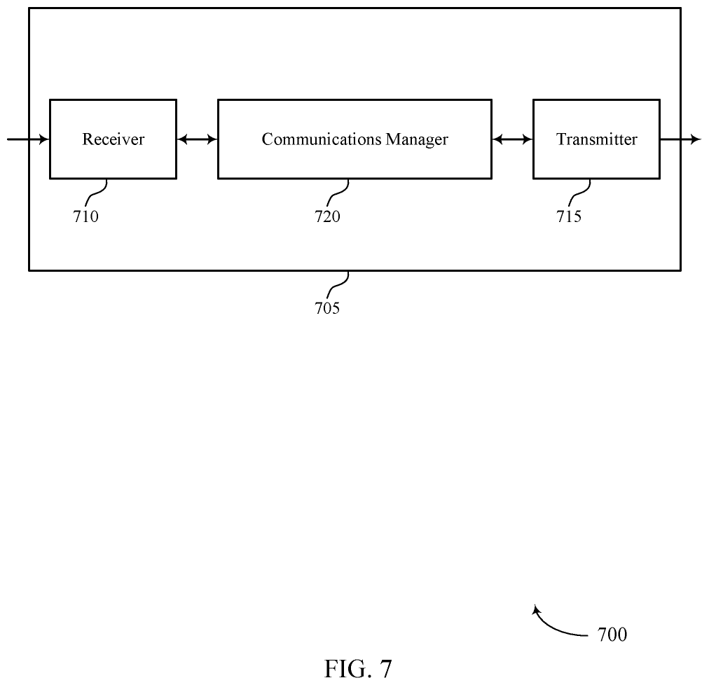

FIG. 7 shows a block diagram 700 of a device 705 that supports a skipping indication for a time window of scheduled resources in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to skipping indication for a time window of scheduled resources). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to skipping indication for a time window of scheduled resources). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of skipping indication for a time window of scheduled resources as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first UE in accordance with examples as disclosed herein. For example, the communications manager 720 is capable of, configured to, or operable to support a means for receiving a first control signal activating a set of pre-configured resources associated with a first time window, where the first time window includes a set of uplink shared channel occasions. The communications manager 720 is capable of, configured to, or operable to support a means for allocating data to a first subset of the set of uplink shared channel occasions. The communications manager 720 is capable of, configured to, or operable to support a means for transmitting the data using the first subset of the set of uplink shared channel occasions. The communications manager 720 is capable of, configured to, or operable to support a means for transmitting, after transmitting the data using the first subset of the set of uplink shared channel occasions, a second control signal indicating that a second subset of the set of uplink shared channel occasions will be skipped for uplink data transmission by the first UE.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced processing, reduced power consumption, and more efficient utilization of communication resources.

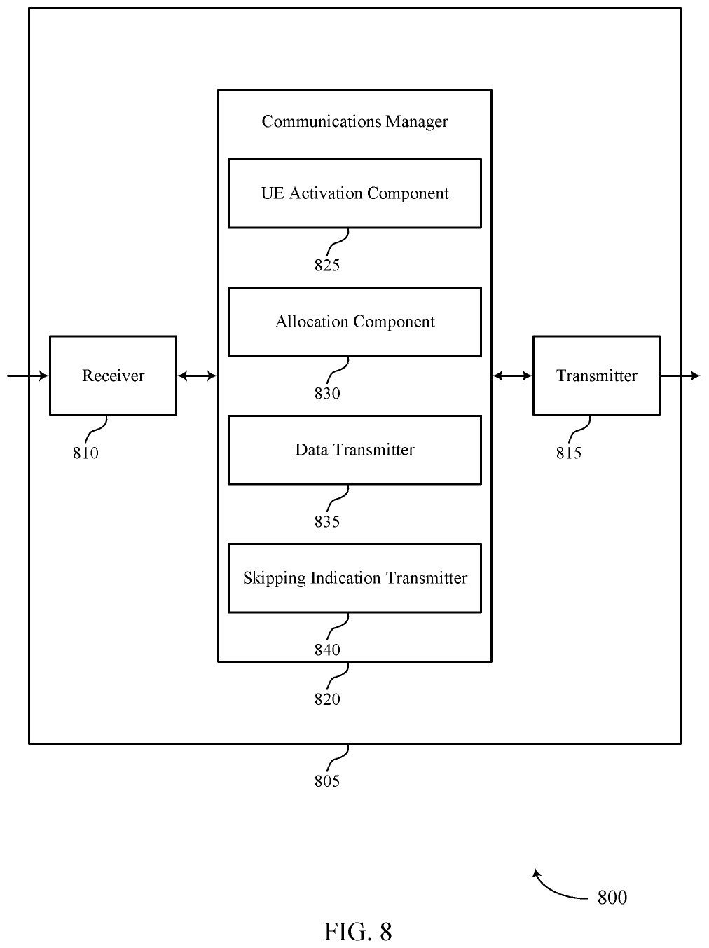

FIG. 8 shows a block diagram 800 of a device 805 that supports a skipping indication for a time window of scheduled resources in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to skipping indication for a time window of scheduled resources). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to skipping indication for a time window of scheduled resources). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of skipping indication for a time window of scheduled resources as described herein. For example, the communications manager 820 may include a UE activation component 825, an allocation component 830, a data transmitter 835, a skipping indication transmitter 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first UE in accordance with examples as disclosed herein. The UE activation component 825 is capable of, configured to, or operable to support a means for receiving a first control signal activating a set of pre-configured resources associated with a first time window, where the first time window includes a set of uplink shared channel occasions. The allocation component 830 is capable of, configured to, or operable to support a means for allocating data to a first subset of the set of uplink shared channel occasions. The data transmitter 835 is capable of, configured to, or operable to support a means for transmitting the data using the first subset of the set of uplink shared channel occasions. The skipping indication transmitter 840 is capable of, configured to, or operable to support a means for transmitting, after transmitting the data using the first subset of the set of uplink shared channel occasions, a second control signal indicating that a second subset of the set of uplink shared channel occasions will be skipped for uplink data transmission by the first UE.

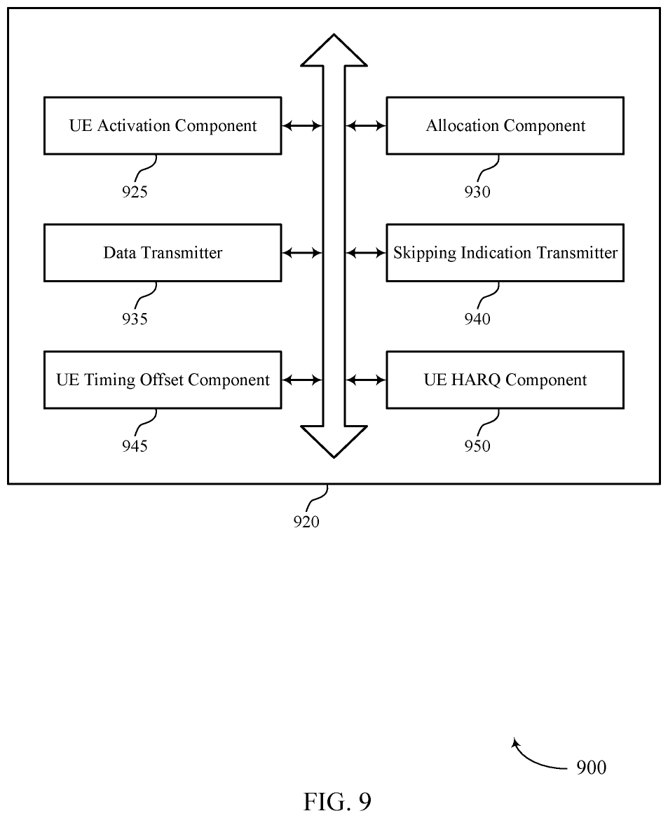

FIG. 9 shows a block diagram 900 of a communications manager 920 that supports a skipping indication for a time window of scheduled resources in accordance with one or more aspects of the present disclosure. The communications manager 920 may be an example of aspects of a communications manager 720, a communications manager 820, or both, as described herein. The communications manager 920, or various components thereof, may be an example of means for performing various aspects of skipping indication for a time window of scheduled resources as described herein. For example, the communications manager 920 may include a UE activation component 925, an allocation component 930, a data transmitter 935, a skipping indication transmitter 940, a UE timing offset component 945, a UE HARQ component 950, or any combination thereof. Each of these components may communicate, directly or indirectly, with one another (e.g., via one or more buses).

The communications manager 920 may support wireless communication at a first UE in accordance with examples as disclosed herein. The UE activation component 925 is capable of, configured to, or operable to support a means for receiving a first control signal activating a set of pre-configured resources associated with a first time window, where the first time window includes a set of uplink shared channel occasions. The allocation component 930 is capable of, configured to, or operable to support a means for allocating data to a first subset of the set of uplink shared channel occasions. The data transmitter 935 is capable of, configured to, or operable to support a means for transmitting the data using the first subset of the set of uplink shared channel occasions. The skipping indication transmitter 940 is capable of, configured to, or operable to support a means for transmitting, after transmitting the data using the first subset of the set of uplink shared channel occasions, a second control signal indicating that a second subset of the set of uplink shared channel occasions will be skipped for uplink data transmission by the first UE.

In some examples, to support transmitting the second control signal, the skipping indication transmitter 940 is capable of, configured to, or operable to support a means for transmitting, within a first timing offset, the second control signal, where the first timing offset is measured from a temporally last uplink shared channel occasion of the set of uplink shared channel occasions and the first timing offset includes a minimum time for a network entity to skip decoding of the second subset of the set of uplink shared channel occasions.

In some examples, the first time window is associated with a second time window that includes a first set of retransmission occasions, and the allocation component 930 is capable of, configured to, or operable to support a means for allocating the data to a first subset of the first set of retransmission occasions. In some examples, the first time window is associated with a second time window that includes a first set of retransmission occasions, and the data transmitter 935 is capable of, configured to, or operable to support a means for transmitting the data using the first subset of the first set of retransmission occasions.

In some examples, to support transmitting the second control signal, the skipping indication transmitter 940 is capable of, configured to, or operable to support a means for transmitting, outside of a first timing offset and within a second timing offset, the second control signal, where the first timing offset is measured from a temporally last uplink shared channel occasion of the set of uplink shared channel occasions and the first timing offset includes a minimum time for a network entity to skip decoding of the second subset of the set of uplink shared channel occasions, and where the second timing offset is measured from the temporally last uplink shared channel occasion of the set of uplink shared channel occasions and the second timing offset includes a minimum time for the network entity to reallocate a second subset of the first set of retransmission occasions to a second UE.

In some examples, the second control signal further indicates that the second subset of the first set of retransmission occasions will be skipped for uplink data transmission by the first UE. In some examples, the UE timing offset component 945 is capable of, configured to, or operable to support a means for receiving a first signal indicating the first timing offset, the second timing offset, or both. In some examples, the data transmitter 935 is capable of, configured to, or operable to support a means for transmitting second data using a second subset of the first set of retransmission occasions.

In some examples, to support transmitting the second control signal, the skipping indication transmitter 940 is capable of, configured to, or operable to support a means for transmitting the second control signal indicating that the second subset of the first set of retransmission occasions will be used for transmission of the second data.

In some examples, the UE HARQ component 950 is capable of, configured to, or operable to support a means for transmitting a third control signal indicating a hybrid automatic repeat request identifier associated with the second data.

In some examples, the first time window is associated with a third time window that includes a second set of retransmission occasions, and the allocation component 930 is capable of, configured to, or operable to support a means for allocating the data to a first subset of the second set of retransmission occasions. In some examples, the first time window is associated with a third time window that includes a second set of retransmission occasions, and the data transmitter 935 is capable of, configured to, or operable to support a means for transmitting the data using the first subset of the second set of retransmission occasions.

In some examples, the second control signal further indicates one or both of a second subset of the first set of retransmission occasions or a second subset of the second set of retransmission occasions will be skipped for uplink transmission by the first UE.

In some examples, the second control signal indicates a bitmap including a set of bits, each bit of the set of bits corresponding to a respective uplink shared channel occasion of the set of uplink shared channel occasions, a respective retransmission occasion of the first set of retransmission occasions, or a respective retransmission occasion of the second set of retransmission occasions. In some examples, a logic value of the bit indicates whether the respective uplink shared channel occasion of the set of uplink shared channel occasions, the respective retransmission occasion of the first set of retransmission occasions, or the respective retransmission occasion of the second set of retransmission occasions will be used for uplink data transmission by the first UE.

In some examples, to support transmitting the second control signal, the skipping indication transmitter 940 is capable of, configured to, or operable to support a means for transmitting UCI, a MAC-CE, RRC signaling, a feedback message, a RACH message, a CSI message, a BSR message, a PHR message, or a SR, the UCI, the MAC-CE, the RRC signaling, the feedback message, the RACH message, the CSI message, the BSR message, the PHR message, or the SR including the second control signal.

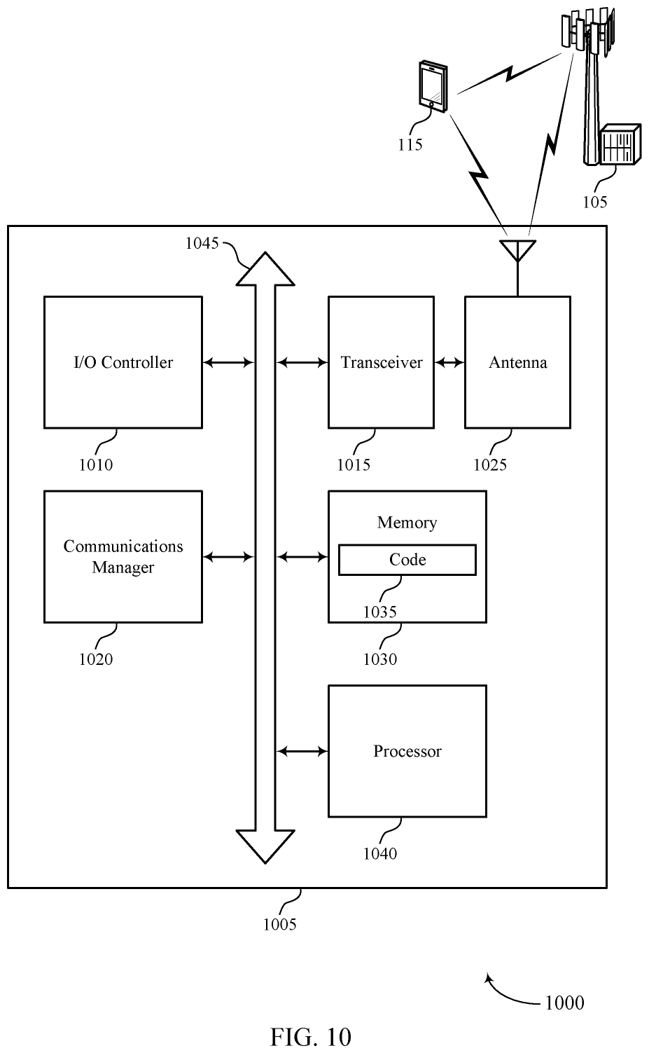

FIG. 10 shows a diagram of a system 1000 including a device 1005 that supports a skipping indication for a time window of scheduled resources in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting skipping indication for a time window of scheduled resources). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a first UE in accordance with examples as disclosed herein. For example, the communications manager 1020 is capable of, configured to, or operable to support a means for receiving a first control signal activating a set of pre-configured resources associated with a first time window, where the first time window includes a set of uplink shared channel occasions. The communications manager 1020 is capable of, configured to, or operable to support a means for allocating data to a first subset of the set of uplink shared channel occasions. The communications manager 1020 is capable of, configured to, or operable to support a means for transmitting the data using the first subset of the set of uplink shared channel occasions. The communications manager 1020 is capable of, configured to, or operable to support a means for transmitting, after transmitting the data using the first subset of the set of uplink shared channel occasions, a second control signal indicating that a second subset of the set of uplink shared channel occasions will be skipped for uplink data transmission by the first UE.

By including or configuring the communications manager 1020 in accordance with examples as described herein, the device 1005 may support techniques for reduced latency, reduced power consumption, and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of skipping indication for a time window of scheduled resources as described herein, or the processor 1040 and the memory 1030 may be otherwise configured to perform or support such operations.

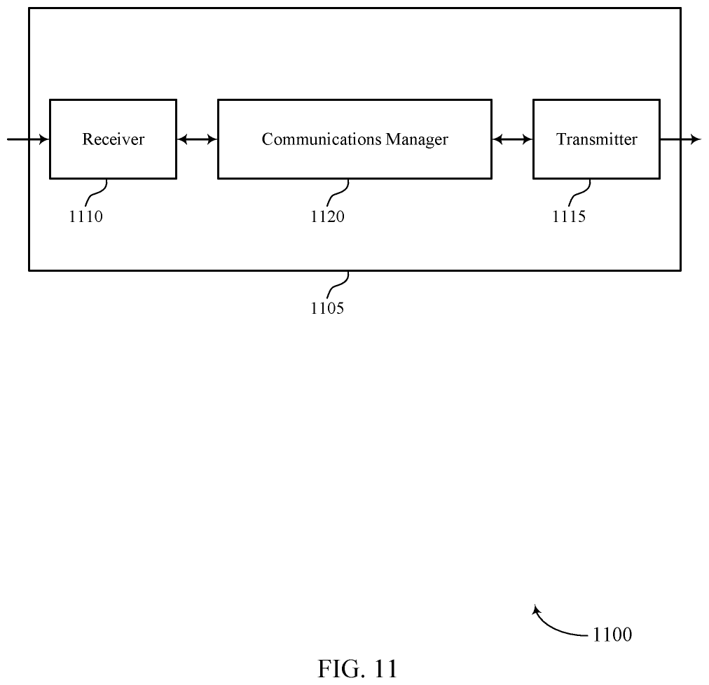

FIG. 11 shows a block diagram 1100 of a device 1105 that supports a skipping indication for a time window of scheduled resources in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of skipping indication for a time window of scheduled resources as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 is capable of, configured to, or operable to support a means for transmitting a first control signal activating a set of pre-configured resources associated with a first time window, where the first time window includes a set of uplink shared channel occasions. The communications manager 1120 is capable of, configured to, or operable to support a means for receiving, from a first UE, data using a first subset of the set of uplink shared channel occasions. The communications manager 1120 is capable of, configured to, or operable to support a means for receiving, after receiving the data using the first subset of the set of uplink shared channel occasions, a second control signal indicating that a second subset of the set of uplink shared channel occasions will be skipped for uplink data transmission by the first UE.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced processing, reduced power consumption, and more efficient utilization of communication resources.

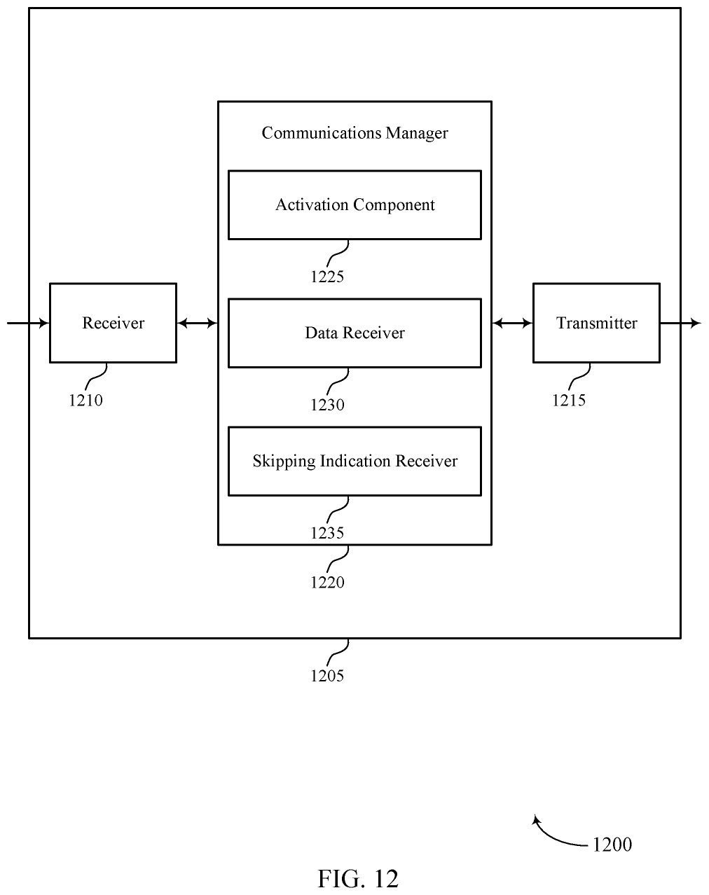

FIG. 12 shows a block diagram 1200 of a device 1205 that supports a skipping indication for a time window of scheduled resources in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of skipping indication for a time window of scheduled resources as described herein. For example, the communications manager 1220 may include an activation component 1225, a data receiver 1230, a skipping indication receiver 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The activation component 1225 is capable of, configured to, or operable to support a means for transmitting a first control signal activating a set of pre-configured resources associated with a first time window, where the first time window includes a set of uplink shared channel occasions. The data receiver 1230 is capable of, configured to, or operable to support a means for receiving, from a first UE, data using a first subset of the set of uplink shared channel occasions. The skipping indication receiver 1235 is capable of, configured to, or operable to support a means for receiving, after receiving the data using the first subset of the set of uplink shared channel occasions, a second control signal indicating that a second subset of the set of uplink shared channel occasions will be skipped for uplink data transmission by the first UE.

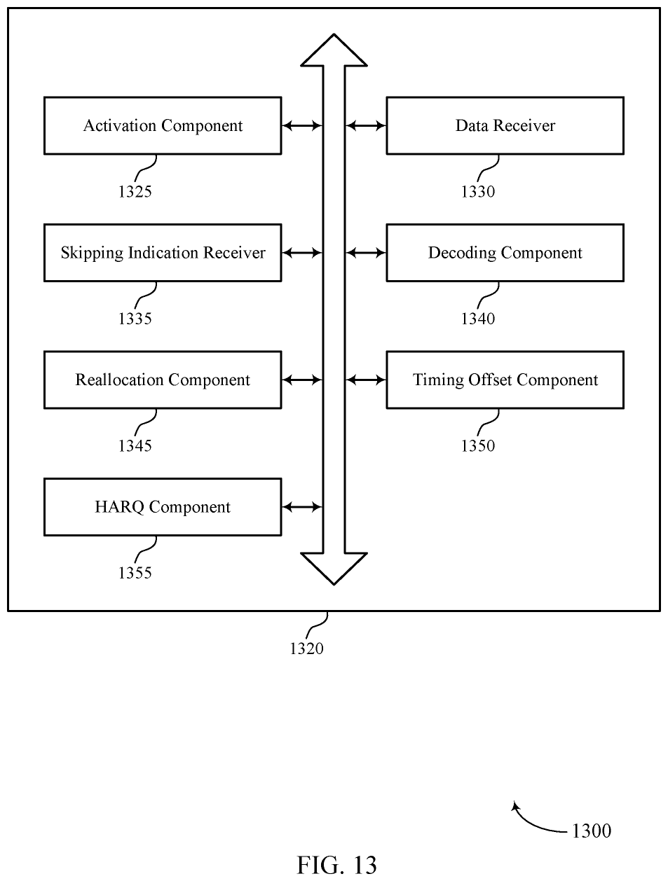

FIG. 13 shows a block diagram 1300 of a communications manager 1320 that supports a skipping indication for a time window of scheduled resources in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of skipping indication for a time window of scheduled resources as described herein. For example, the communications manager 1320 may include an activation component 1325, a data receiver 1330, a skipping indication receiver 1335, a decoding component 1340, a reallocation component 1345, a timing offset component 1350, an HARQ component 1355, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The activation component 1325 is capable of, configured to, or operable to support a means for transmitting a first control signal activating a set of pre-configured resources associated with a first time window, where the first time window includes a set of uplink shared channel occasions. The data receiver 1330 is capable of, configured to, or operable to support a means for receiving, from a first UE, data using a first subset of the set of uplink shared channel occasions. The skipping indication receiver 1335 is capable of, configured to, or operable to support a means for receiving, after receiving the data using the first subset of the set of uplink shared channel occasions, a second control signal indicating that a second subset of the set of uplink shared channel occasions will be skipped for uplink data transmission by the first UE.

In some examples, the decoding component 1340 is capable of, configured to, or operable to support a means for skipping decoding of the second subset of the set of uplink shared channel occasions based on receiving the second control signal within a first timing offset, the first timing offset measured from a temporally last uplink shared channel occasion of the set of uplink shared channel occasions and the first timing offset including a minimum time for the network entity to skip decoding of the second subset of the set of uplink shared channel occasions.

In some examples, the first time window is associated with a second time window that includes a first set of retransmission occasions, and the data receiver 1330 is capable of, configured to, or operable to support a means for receiving the data using the first subset of the first set of retransmission occasions.

In some examples, to support receiving the second control signal, the reallocation component 1345 is capable of, configured to, or operable to support a means for reallocating a second subset of the first set of retransmission occasions to a second UE based on receiving the second control signal outside of a first timing offset and within a second timing offset, the first timing offset measured from a temporally last uplink shared channel occasion of the set of uplink shared channel occasions and the first timing offset including a minimum time for the network entity to skip decoding of the second subset of the set of uplink shared channel occasions, wherein the second timing offset is measured from the temporally last uplink shared channel occasion of the set of uplink shared channel occasions and the second timing offset includes a minimum time for the network entity to reallocate a second subset of the first set of retransmission occasions to a second UE.

In some examples, the second control signal further indicates that the second subset of the first set of retransmission occasions will be skipped for uplink data transmission by the first UE. In some examples, the timing offset component 1350 is capable of, configured to, or operable to support a means for transmitting a first signal indicating the first timing offset, the second timing offset, or both. In some examples, the data receiver 1330 is capable of, configured to, or operable to support a means for receiving, from the first UE, second data using a second subset of the first set of retransmission occasions.

In some examples, to support receiving the second control signal, the skipping indication receiver 1335 is capable of, configured to, or operable to support a means for receiving the second control signal indicating that the second subset of the first set of retransmission occasions will be used for transmission of the second data.

In some examples, the HARQ component 1355 is capable of, configured to, or operable to support a means for receiving a third control signal indicating a hybrid automatic repeat request identifier associated with the second data.

In some examples, the first time window is associated with a third time window that includes a second set of retransmission occasions, and the data receiver 1330 is capable of, configured to, or operable to support a means for receiving the data using the first subset of the second set of retransmission occasions.

In some examples, the second control signal further indicates one or both of a second subset of the first set of retransmission occasions or a second subset of the second set of retransmission occasions will be skipped for uplink transmission by the first UE.

In some examples, the second control signal indicates a bitmap including a set of bits, each bit of the set of bits corresponding to a respective uplink shared channel occasion of the set of uplink shared channel occasions, a respective retransmission occasion of the first set of retransmission occasions, or a respective retransmission occasion of the second set of retransmission occasions. In some examples, a logic value of the bit indicates whether the respective uplink shared channel occasion of the set of uplink shared channel occasions, the respective retransmission occasion of the first set of retransmission occasions, or the respective retransmission occasion of the second set of retransmission occasions will be used for uplink data transmission by the first UE.

In some examples, to support receiving the second control signal, the skipping indication receiver 1335 is capable of, configured to, or operable to support a means for receiving UCI, a MAC-CE, RRC signaling, a feedback message, a RACH message, a CSI message, a BSR message, a PHR message, or a SR, the UCI, the MAC-CE, the RRC signaling, the feedback message, the RACH message, the CSI message, the BSR message, the PHR message, or the SR including the second control signal.

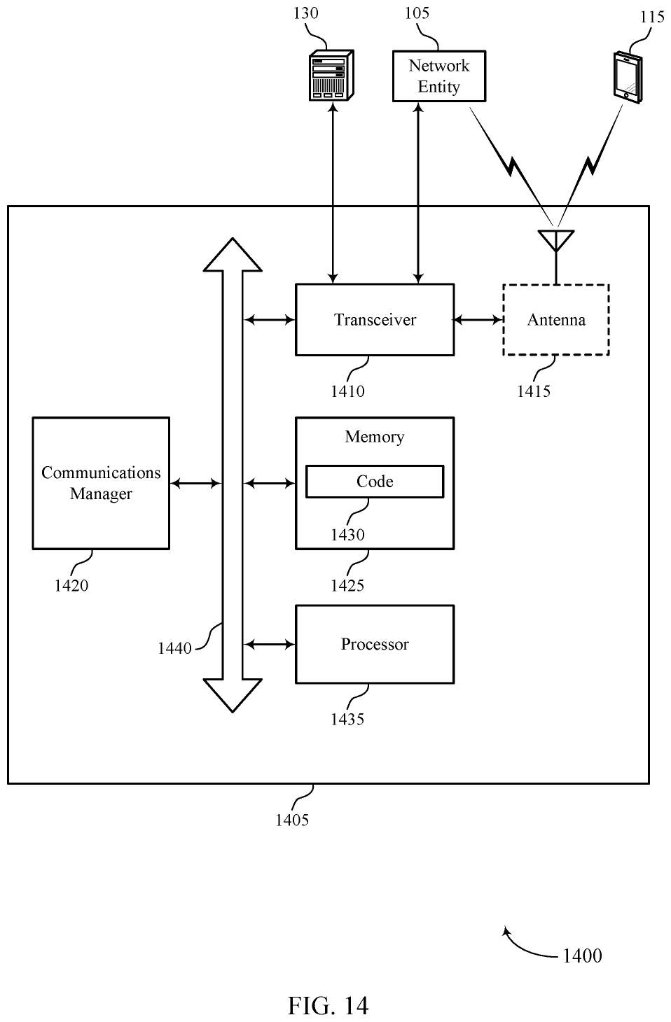

FIG. 14 shows a diagram of a system 1400 including a device 1405 that supports a skipping indication for a time window of scheduled resources in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting skipping indication for a time window of scheduled resources). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 is capable of, configured to, or operable to support a means for transmitting a first control signal activating a set of pre-configured resources associated with a first time window, where the first time window includes a set of uplink shared channel occasions. The communications manager 1420 is capable of, configured to, or operable to support a means for receiving, from a first UE, data using a first subset of the set of uplink shared channel occasions. The communications manager 1420 is capable of, configured to, or operable to support a means for receiving, after receiving the data using the first subset of the set of uplink shared channel occasions, a second control signal indicating that a second subset of the set of uplink shared channel occasions will be skipped for uplink data transmission by the first UE.

By including or configuring the communications manager 1420 in accordance with examples as described herein, the device 1405 may support techniques for reduced latency, reduced power consumption, and more efficient utilization of communication resources.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of skipping indication for a time window of scheduled resources as described herein, or the processor 1435 and the memory 1425 may be otherwise configured to perform or support such operations.

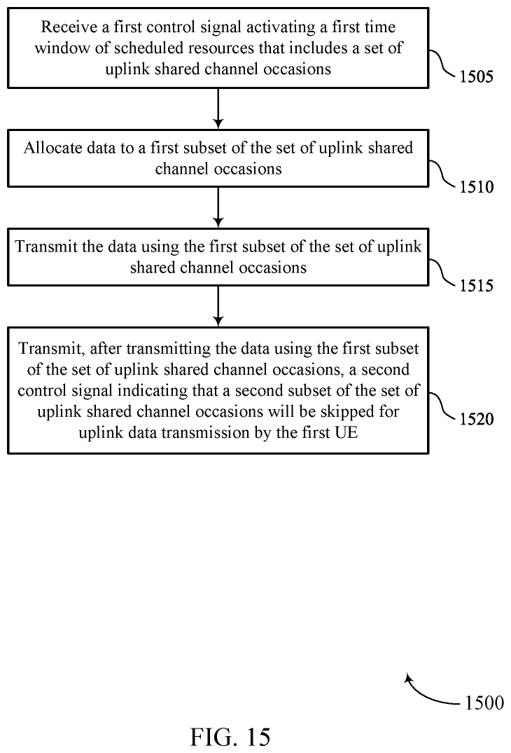

FIG. 15 shows a flowchart illustrating a method 1500 that supports a skipping indication for a time window of scheduled resources in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the wireless UE to perform the described functions. Additionally, or alternatively, the wireless UE may perform aspects of the described functions using special-purpose hardware.

At 1505, the method may include receiving a first control signal activating set of pre-configured resources associated with a first time window, where the first time window includes a set of uplink shared channel occasions. The operations of 1505 may be performed in accordance with examples as disclosed herein. In some examples, aspects of the operations of 1505 may be performed by a UE activation component 925 as described with reference to FIG. 9.

At 1510, the method may include allocating data to a first subset of the set of uplink shared channel occasions. The operations of 1510 may be performed in accordance with examples as disclosed herein. In some examples, aspects of the operations of 1510 may be performed by an allocation component 930 as described with reference to FIG. 9.

At 1515, the method may include transmitting the data using the first subset of the set of uplink shared channel occasions. The operations of 1515 may be performed in accordance with examples as disclosed herein. In some examples, aspects of the operations of 1515 may be performed by a data transmitter 935 as described with reference to FIG. 9.

At 1520, the method may include transmitting, after transmitting the data using the first subset of the set of uplink shared channel occasions, a second control signal indicating that a second subset of the set of uplink shared channel occasions will be skipped for uplink data transmission by the first UE. The operations of 1520 may be performed in accordance with examples as disclosed herein. In some examples, aspects of the operations of 1520 may be performed by a skipping indication transmitter 940 as described with reference to FIG. 9.

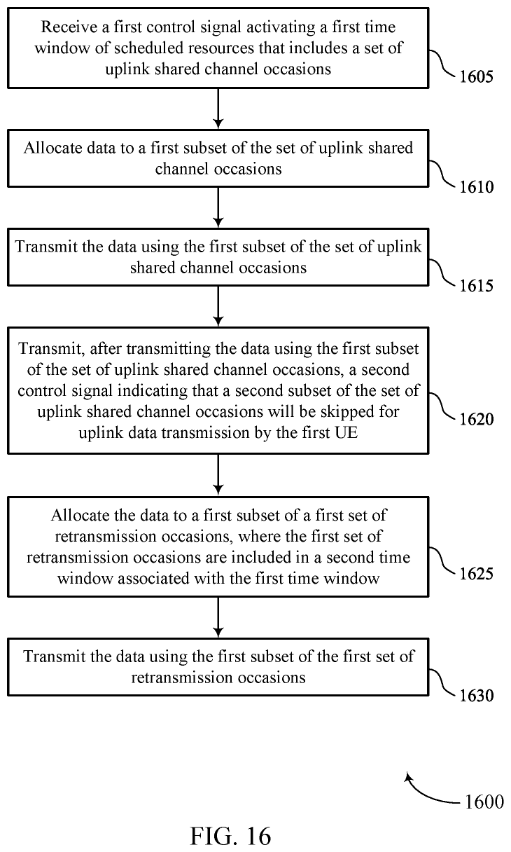

FIG. 16 shows a flowchart illustrating a method 1600 that supports a skipping indication for a time window of scheduled resources in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the wireless UE to perform the described functions. Additionally, or alternatively, the wireless UE may perform aspects of the described functions using special-purpose hardware.

At 1605, the method may include receiving a first control signal activating a set of pre-configured resources associated with a first time window, where the first time window includes a set of uplink shared channel occasions. The operations of 1605 may be performed in accordance with examples as disclosed herein. In some examples, aspects of the operations of 1605 may be performed by a UE activation component 925 as described with reference to FIG. 9.

At 1610, the method may include allocating data to a first subset of the set of uplink shared channel occasions. The operations of 1610 may be performed in accordance with examples as disclosed herein. In some examples, aspects of the operations of 1610 may be performed by an allocation component 930 as described with reference to FIG. 9.

At 1615, the method may include transmitting the data using the first subset of the set of uplink shared channel occasions. The operations of 1615 may be performed in accordance with examples as disclosed herein. In some examples, aspects of the operations of 1615 may be performed by a data transmitter 935 as described with reference to FIG. 9.

At 1620, the method may include transmitting, after transmitting the data using the first subset of the set of uplink shared channel occasions, a second control signal indicating that a second subset of the set of uplink shared channel occasions will be skipped for uplink data transmission by the first UE. The operations of 1620 may be performed in accordance with examples as disclosed herein. In some examples, aspects of the operations of 1620 may be performed by a skipping indication transmitter 940 as described with reference to FIG. 9.

At 1625, the method may include allocating the data to a first subset of the first set of retransmission occasions, where the first set of retransmission occasions are included in a second time window associated with the first time window. The operations of 1625 may be performed in accordance with examples as disclosed herein. In some examples, aspects of the operations of 1625 may be performed by an allocation component 930 as described with reference to FIG. 9.

At 1630, the method may include transmitting the data using the first subset of the first set of retransmission occasions. The operations of 1630 may be performed in accordance with examples as disclosed herein. In some examples, aspects of the operations of 1630 may be performed by a data transmitter 935 as described with reference to FIG. 9.

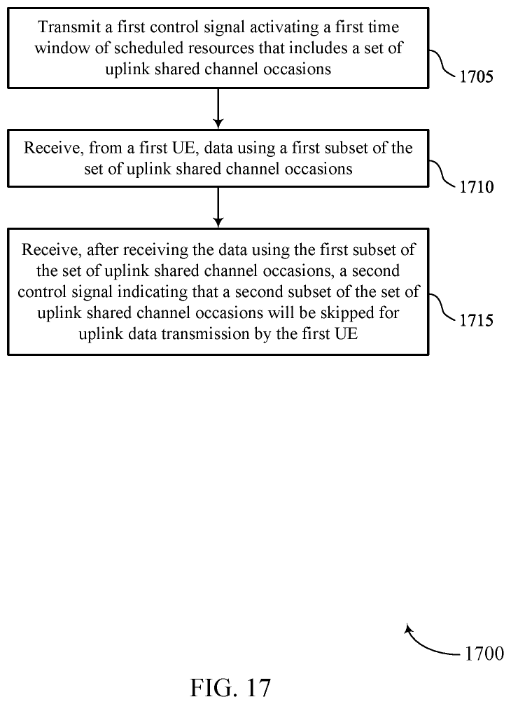

FIG. 17 shows a flowchart illustrating a method 1700 that supports skipping indication for a time window of scheduled resources in accordance with aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the wireless network entity to perform the described functions. Additionally, or alternatively, the wireless network entity may perform aspects of the described functions using special-purpose hardware.

At 1705, the method may include transmitting a first control signal activating a set of pre-configured resources associated with a first time window, where the first time window includes a set of uplink shared channel occasions. The operations of 1705 may be performed in accordance with examples as disclosed herein. In some examples, aspects of the operations of 1705 may be performed by an activation component 1325 as described with reference to FIG. 13.

At 1710, the method may include receiving, from a first UE, data using a first subset of the set of uplink shared channel occasions. The operations of 1710 may be performed in accordance with examples as disclosed herein. In some examples, aspects of the operations of 1710 may be performed by a data receiver 1330 as described with reference to FIG. 13.

At 1715, the method may include receiving, after receiving the data using the first subset of the set of uplink shared channel occasions, a second control signal indicating that a second subset of the set of uplink shared channel occasions will be skipped for uplink data transmission by the first UE. The operations of 1715 may be performed in accordance with examples as disclosed herein. In some examples, aspects of the operations of 1715 may be performed by a skipping indication receiver 1335 as described with reference to FIG. 13.

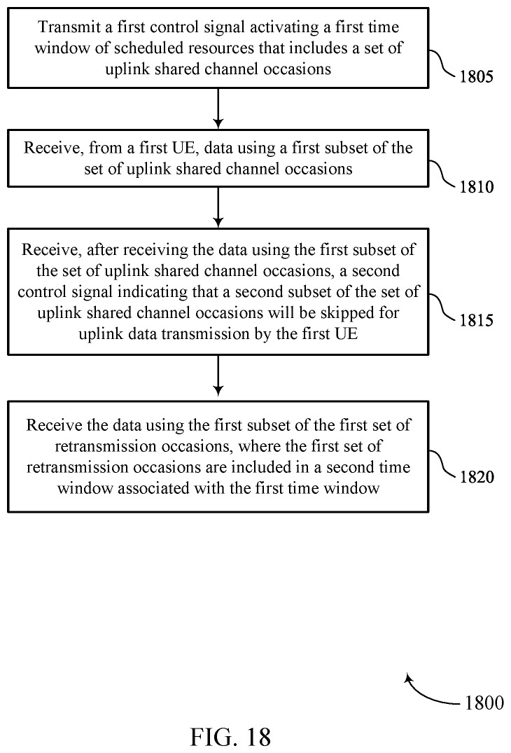

FIG. 18 shows a flowchart illustrating a method 1800 that supports skipping indication for a time window of scheduled resources in accordance with aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the wireless network entity to perform the described functions. Additionally, or alternatively, the wireless network entity may perform aspects of the described functions using special-purpose hardware.

At 1805, the method may include transmitting a first control signal activating a set of pre-configured resources associated with a first time window, where the first time window includes a set of uplink shared channel occasions. The operations of 1805 may be performed in accordance with examples as disclosed herein. In some examples, aspects of the operations of 1805 may be performed by an activation component 1325 as described with reference to FIG. 13.

At 1810, the method may include receiving, from a first UE, data using a first subset of the set of uplink shared channel occasions. The operations of 1810 may be performed in accordance with examples as disclosed herein. In some examples, aspects of the operations of 1810 may be performed by a data receiver 1330 as described with reference to FIG. 13.

At 1815, the method may include receiving, after receiving the data using the first subset of the set of uplink shared channel occasions, a second control signal indicating that a second subset of the set of uplink shared channel occasions will be skipped for uplink data transmission by the first UE. The operations of 1815 may be performed in accordance with examples as disclosed herein. In some examples, aspects of the operations of 1815 may be performed by a skipping indication receiver 1335 as described with reference to FIG. 13.

At 1820, the method may include receiving the data using the first subset of the first set of retransmission occasions, where the first set of retransmission occasions are included in a second time window associated with the first time window. The operations of 1820 may be performed in accordance with examples as disclosed herein. In some examples, aspects of the operations of 1820 may be performed by a data receiver 1330 as described with reference to FIG. 13.

The following provides an overview of aspects of the present disclosure:

Aspect 1: A method for wireless communication at a first UE, comprising: receiving a first control signal activating a set of pre-configured resources associated with a first time window, wherein the first time window comprises a set of uplink shared channel occasions; allocating data to a first subset of the set of uplink shared channel occasions; transmitting the data using the first subset of the set of uplink shared channel occasions; and transmitting, after transmitting the data using the first subset of the set of uplink shared channel occasions, a second control signal indicating that a second subset of the set of uplink shared channel occasions will be skipped for uplink data transmission by the first UE.

Aspect 2: The method of aspect 1, wherein transmitting the second control signal comprises: transmitting, within a first timing offset, the second control signal, wherein the first timing offset is measured from a temporally last uplink shared channel occasion of the set of uplink shared channel occasions and wherein the first timing offset comprises a minimum time for a network entity to skip decoding of the second subset of the set of uplink shared channel occasions.

Aspect 3: The method of any of aspects 1 through 2, wherein the first time window is associated with a second time window that comprises a first set of retransmission occasions, the method further comprising: allocating the data to a first subset of the first set of retransmission occasions; and transmitting the data using the first subset of the first set of retransmission occasions.

Aspect 4: The method of aspect 3, wherein transmitting the second control signal comprises: transmitting, outside of a first timing offset and within a second timing offset, the second control signal, wherein the first timing offset is measured from a temporally last uplink shared channel occasion of the set of uplink shared channel occasions and the first timing offset comprises a minimum time for a network entity to skip decoding of the second subset of the set of uplink shared channel occasions, and wherein the second timing offset is measured from the temporally last uplink shared channel occasion of the set of uplink shared channel occasions and the second timing offset comprises a minimum time for the network entity to reallocate a second subset of the first set of retransmission occasions to a second UE.

Aspect 5: The method of aspect 4, wherein the second control signal further indicates that the second subset of the first set of retransmission occasions will be skipped for uplink data transmission by the first UE.

Aspect 6: The method of any of aspects 4 through 5, further comprising: receiving a first signal indicating the first timing offset, the second timing offset, or both.

Aspect 7: The method of any of aspects 3 through 6, further comprising: transmitting second data using a second subset of the first set of retransmission occasions.

Aspect 8: The method of aspect 7, wherein transmitting the second control signal comprises: transmitting the second control signal indicating that the second subset of the first set of retransmission occasions will be used for transmission of the second data.

Aspect 9: The method of any of aspects 7 through 8, further comprising: transmitting a third control signal indicating a HARQ ID associated with the second data.

Aspect 10: The method of any of aspects 3 through 9, wherein the first time window is associated with a third time window that comprises a second set of retransmission occasions, the method further comprising: allocating the data to a first subset of the second set of retransmission occasions; and transmitting the data using the first subset of the second set of retransmission occasions.

Aspect 11: The method of aspect 10, wherein the second control signal further indicates one or both of a second subset of the first set of retransmission occasions or a second subset of the second set of retransmission occasions will be skipped for uplink transmission by the first UE.

Aspect 12: The method of aspect 11, wherein the second control signal indicates a bitmap comprising a set of bits, each bit of the set of bits corresponding to a respective uplink shared channel occasion of the set of uplink shared channel occasions, a respective retransmission occasion of the first set of retransmission occasions, or a respective retransmission occasion of the second set of retransmission occasions, and a logic value of the bit indicates whether the respective uplink shared channel occasion of the set of uplink shared channel occasions, the respective retransmission occasion of the first set of retransmission occasions, or the respective retransmission occasion of the second set of retransmission occasions will be used for uplink data transmission by the first UE.

Aspect 13: The method of any of aspects 1 through 12, wherein transmitting the second control signal comprises: transmitting UCI, a MAC-CE, RRC signaling, a feedback message, a RACH message, a CSI message, a BSR message, a PHR message, or a SR, the UCI, the MAC-CE, the RRC signaling, the feedback message, the RACH message, the CSI message, the BSR message, the PHR message, or the SR comprising the second control signal.

Aspect 14: A method for wireless communication at a network entity, comprising: transmitting a first control signal activating a set of pre-configured resource associated with a first time window wherein the first time window comprises a set of uplink shared channel occasions; receiving, from a first UE, data using a first subset of the set of uplink shared channel occasions; and receiving, after receiving the data using the first subset of the set of uplink shared channel occasions, a second control signal indicating that a second subset of the set of uplink shared channel occasions will be skipped for uplink data transmission by the first UE.

Aspect 15: The method of aspect 14, further comprising: skipping decoding of the second subset of the set of uplink shared channel occasions based at least in part on receiving the second control signal within a first timing offset, the first timing offset measured from a temporally last uplink shared channel occasion of the set of uplink shared channel occasions and the first timing offset comprising a minimum time for the network entity to skip decoding of the second subset of the set of uplink shared channel occasions.

Aspect 16: The method of any of aspects 14 through 15, wherein the first time window is associated with a second time window that comprises a first set of retransmission occasions, the method further comprising: receiving the data using the first subset of the first set of retransmission occasions.

Aspect 17: The method of aspect 16, wherein receiving the second control signal comprises: reallocating a second subset of the first set of retransmission occasions to a second UE based at least in part on receiving the second control signal outside of a first timing offset and within a second timing offset, the first timing offset measured from a temporally last uplink shared channel occasion of the set of uplink shared channel occasions and the first timing offset comprising a minimum time for the network entity to skip decoding of the second subset of the set of uplink shared channel occasions, wherein the second timing offset is measured from the temporally last uplink shared channel occasion of the set of uplink shared channel occasions and the second timing offset comprises a minimum time for the network entity to reallocate a second subset of the first set of retransmission occasions to a second UE.

Aspect 18: The method of aspect 17, wherein the second control signal further indicates that the second subset of the first set of retransmission occasions will be skipped for uplink data transmission by the first UE.

Aspect 19: The method of any of aspects 17 through 18, further comprising: transmitting a first signal indicating the first timing offset, the second timing offset, or both.

Aspect 20: The method of aspect 16, further comprising: receiving, from the first UE, second data using a second subset of the first set of retransmission occasions.

Aspect 21: The method of aspect 20, wherein receiving the second control signal comprises: receiving the second control signal indicating that the second subset of the first set of retransmission occasions will be used for transmission of the second data.

Aspect 22: The method of any of aspects 20 through 21, further comprising: receiving a third control signal indicating a HARQ ID associated with the second data.

Aspect 23: The method of any of aspects 16 through 22, wherein the first time window is associated with a third time window that comprises a second set of retransmission occasions, the method further comprising: receiving the data using the first subset of the second set of retransmission occasions.

Aspect 24: The method of aspect 23, wherein the second control signal further indicates one or both of a second subset of the first set of retransmission occasions or a second subset of the second set of retransmission occasions will be skipped for uplink transmission by the first UE.

Aspect 25: The method of aspect 24, wherein the second control signal indicates a bitmap comprising a set of bits, each bit of the set of bits corresponding to a respective uplink shared channel occasion of the set of uplink shared channel occasions, a respective retransmission occasion of the first set of retransmission occasions, or a respective retransmission occasion of the second set of retransmission occasions, and a logic value of the bit indicates whether the respective uplink shared channel occasion of the set of uplink shared channel occasions, the respective retransmission occasion of the first set of retransmission occasions, or the respective retransmission occasion of the second set of retransmission occasions will be used for uplink data transmission by the first UE.

Aspect 26: The method of any of aspects 14 through 25, wherein receiving the second control signal comprises: receiving UCI, a MAC-CE, RRC signaling, a feedback message, a RACH message, a CSI message, a BSR message, a PHR message, or a SR, the UCI, the MAC-CE, the RRC signaling, the feedback message, the RACH message, the CSI message, the BSR message, the PHR message, or the SR comprising the second control signal.

Aspect 27: An apparatus for wireless communication at a first UE, comprising a processor; memory coupled with the processor; and instructions stored in the memory and executable by the processor to cause the apparatus to perform a method of any of aspects 1 through 13.

Aspect 28: An apparatus for wireless communication at a first UE, comprising at least one means for performing a method of any of aspects 1 through 13.

Aspect 29: A non-transitory computer-readable medium storing code for wireless communication at a first UE, the code comprising instructions executable by a processor to perform a method of any of aspects 1 through 13.

Aspect 30: An apparatus for wireless communication at a network entity, comprising a processor; memory coupled with the processor; and instructions stored in the memory and executable by the processor to cause the apparatus to perform a method of any of aspects 14 through 26.

Aspect 31: An apparatus for wireless communication at a network entity, comprising at least one means for performing a method of any of aspects 14 through 26.

Aspect 32: A non-transitory computer-readable medium storing code for wireless communication at a network entity, the code comprising instructions executable by a processor to perform a method of any of aspects 14 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first user equipment (UE), comprising:
a processor;
memory coupled with the processor; and
instructions stored in the memory and executable by the processor to cause the apparatus to:
receive a first control signal activating a set of pre-configured resources associated with a first time window, wherein the first time window comprises a set of uplink shared channel occasions;
allocate data to a first subset of the set of uplink shared channel occasions;
transmit the data using the first subset of the set of uplink shared channel occasions; and
transmit, after transmitting the data using the first subset of the set of uplink shared channel occasions, a second control signal indicating that a second subset of the set of uplink shared channel occasions will be skipped for uplink data transmission by the first UE.

2. The apparatus of claim 1, wherein the instructions to transmit the second control signal are executable by the processor to cause the apparatus to:
transmit, within a first timing offset, the second control signal, wherein the first timing offset is measured from a temporally last uplink shared channel occasion of the set of uplink shared channel occasions, and wherein the first timing offset comprises a minimum time for a network entity to skip decoding of the second subset of the set of uplink shared channel occasions.

3. The apparatus of claim 1, wherein the first time window is associated with a second time window that comprises a first set of retransmission occasions, and the instructions are further executable by the processor to cause the apparatus to:
allocate the data to a first subset of the first set of retransmission occasions; and
transmit the data using the first subset of the first set of retransmission occasions.

4. The apparatus of claim 3, wherein the instructions to transmit the second control signal are executable by the processor to cause the apparatus to:
transmit, outside of a first timing offset and within a second timing offset, the second control signal, wherein the first timing offset is measured from a temporally last uplink shared channel occasion of the set of uplink shared channel occasions and the first timing offset comprises a minimum time for a network entity to skip decoding of the second subset of the set of uplink shared channel occasions, and wherein the second timing offset is measured from the temporally last uplink shared channel occasion of the set of uplink shared channel occasions and the second timing offset comprises a minimum time for the network entity to reallocate a second subset of the first set of retransmission occasions to a second UE.

5. The apparatus of claim 4, wherein the second control signal further indicates that the second subset of the first set of retransmission occasions will be skipped for uplink data transmission by the first UE.

6. The apparatus of claim 4, wherein the instructions are further executable by the processor to cause the apparatus to:
receive a first signal indicating the first timing offset, the second timing offset, or both.

7. The apparatus of claim 3, wherein the instructions are further executable by the processor to cause the apparatus to:
transmit second data using a second subset of the first set of retransmission occasions.

8. The apparatus of claim 7, wherein the instructions to transmit the second control signal are executable by the processor to cause the apparatus to:
transmit the second control signal indicating that the second subset of the first set of retransmission occasions will be used for transmission of the second data.

9. The apparatus of claim 7, wherein the instructions are further executable by the processor to cause the apparatus to:
transmit a third control signal indicating a hybrid automatic repeat request identifier associated with the second data.

10. The apparatus of claim 3, wherein the first time window is associated with a third time window that comprises a second set of retransmission occasions, and the instructions are further executable by the processor to cause the apparatus to:
allocate the data to a first subset of the second set of retransmission occasions; and
transmit the data using the first subset of the second set of retransmission occasions.

11. The apparatus of claim 10, wherein the second control signal further indicates one or both of a second subset of the first set of retransmission occasions or a second subset of the second set of retransmission occasions will be skipped for uplink data transmission by the first UE.

12. The apparatus of claim 11, wherein:
the second control signal indicates a bitmap comprising a set of bits, each bit of the set of bits corresponding to a respective uplink shared channel occasion of the set of uplink shared channel occasions, a respective retransmission occasion of the first set of retransmission occasions, or a respective retransmission occasion of the second set of retransmission occasions, and
a logic value of the bit indicates whether the respective uplink shared channel occasion of the set of uplink shared channel occasions, the respective retransmission occasion of the first set of retransmission occasions, or the respective retransmission occasion of the second set of retransmission occasions will be used for uplink data transmission by the first UE.

13. The apparatus of claim 1, wherein the instructions to transmit the second control signal are executable by the processor to cause the apparatus to:
transmit uplink control information, a medium access control control element, radio resource control signaling, a feedback message, a random access channel message, a channel state information message, a buffer status report message, a power headroom report message, or a scheduling request, the uplink control information, the medium access control control element, the radio resource control signaling, the feedback message, the random access channel message, the channel state information message, the buffer status report message, the power headroom report message, or the scheduling request comprising the second control signal.

14. An apparatus for wireless communication at a network entity, comprising:
a processor;
memory coupled with the processor; and
instructions stored in the memory and executable by the processor to cause the apparatus to:
transmit a first control signal activating a set of pre-configured resources associated with a first time window, wherein the first time window comprises a set of uplink shared channel occasions;
receive, from a first user equipment (UE), data using a first subset of the set of uplink shared channel occasions; and
receive, after receiving the data using the first subset of the set of uplink shared channel occasions, a second control signal indicating that a second subset of the set of uplink shared channel occasions will be skipped for uplink data transmission by the first UE.

15. The apparatus of claim 14, wherein the instructions are further executable by the processor to cause the apparatus to:
skip decoding of the second subset of the set of uplink shared channel occasions based at least in part on receiving the second control signal within a first timing offset, the first timing offset measured from a temporally last uplink shared channel occasion of the set of uplink shared channel occasions and the first timing offset comprising a minimum time for the network entity to skip decoding of the second subset of the set of uplink shared channel occasions.

16. The apparatus of claim 14, wherein the first time window is associated with a second time window that comprises a first set of retransmission occasions, and the instructions are further executable by the processor to cause the apparatus to:
receive the data using the first subset of the first set of retransmission occasions.

17. The apparatus of claim 16, wherein the instructions to receive the second control signal are executable by the processor to cause the apparatus to:
reallocate a second subset of the first set of retransmission occasions to a second UE based at least in part on receiving the second control signal outside of a first timing offset and within a second timing offset, the first timing offset measured from a temporally last uplink shared channel occasion of the set of uplink shared channel occasions and the first timing offset comprising a minimum time for the network entity to skip decoding of the second subset of the set of uplink shared channel occasions, wherein the second timing offset is measured from the temporally last uplink shared channel occasion of the set of uplink shared channel occasions and the second timing offset comprises a minimum time for the network entity to reallocate a second subset of the first set of retransmission occasions to a second UE.

18. The apparatus of claim 17, wherein the second control signal further indicates that the second subset of the first set of retransmission occasions will be skipped for uplink data transmission by the first UE.

19. The apparatus of claim 17, wherein the instructions are further executable by the processor to cause the apparatus to:
transmit a first signal indicating the first timing offset, the second timing offset, or both.

20. The apparatus of claim 16, wherein the instructions are further executable by the processor to cause the apparatus to:
receive, from the first UE, second data using a second subset of the first set of retransmission occasions.

21. The apparatus of claim 20, wherein the instructions to receive the second control signal are executable by the processor to cause the apparatus to:
receive the second control signal indicating that the second subset of the first set of retransmission occasions will be used for transmission of the second data.

22. The apparatus of claim 20, wherein the instructions are further executable by the processor to cause the apparatus to:
receive a third control signal indicating a hybrid automatic repeat request identifier associated with the second data.

23. The apparatus of claim 16, wherein the first time window is associated with a third time window that comprises a second set of retransmission occasions, and the instructions are further executable by the processor to cause the apparatus to:
receive the data using the first subset of the second set of retransmission occasions.

24. The apparatus of claim 23, wherein the second control signal further indicates one or both of a second subset of the first set of retransmission occasions or a second subset of the second set of retransmission occasions will be skipped for uplink data transmission by the first UE.

25. The apparatus of claim 24, wherein:
the second control signal indicates a bitmap comprising a set of bits, each bit of the set of bits corresponding to a respective uplink shared channel occasion of the set of uplink shared channel occasions, a respective retransmission occasion of the first set of retransmission occasions, or a respective retransmission occasion of the second set of retransmission occasions, and
a logic value of the bit indicates whether the respective uplink shared channel occasion of the set of uplink shared channel occasions, the respective retransmission occasion of the first set of retransmission occasions, or the respective retransmission occasion of the second set of retransmission occasions will be used for uplink data transmission by the first UE.

26. The apparatus of claim 14, wherein the instructions to receive the second control signal are executable by the processor to cause the apparatus to:
receive uplink control information, a medium access control control element, radio resource control signaling, a feedback message, a random access channel message, a channel state information message, a buffer status report message, a power headroom report message, or a scheduling request, the uplink control information, the medium access control control element, the radio resource control signaling, the feedback message, the random access channel message, the channel state information message, the buffer status report message, the power headroom report message, or the scheduling request comprising the second control signal.

27. A method for wireless communication at a first user equipment (UE), comprising:
receiving a first control signal activating a set of pre-configured resources associated with a first time window, wherein the first time window comprises a set of uplink shared channel occasions;
allocating data to a first subset of the set of uplink shared channel occasions;
transmitting the data using the first subset of the set of uplink shared channel occasions; and
transmitting, after transmitting the data using the first subset of the set of uplink shared channel occasions, a second control signal indicating that a second subset of the set of uplink shared channel occasions will be skipped for uplink data transmission by the first UE.

28. The method of claim 27, wherein transmitting the second control signal comprises:
transmitting, within a first timing offset, the second control signal, wherein the first timing offset is measured from a temporally last uplink shared channel occasion of the set of uplink shared channel occasions, and wherein the first timing offset comprises a minimum time for a network entity to skip decoding of the second subset of the set of uplink shared channel occasions.

29. A method for wireless communication at a network entity, comprising:
transmitting a first control signal activating a set of pre-configured resources associated with a first time window, wherein the first time window comprises a set of uplink shared channel occasions;
receiving, from a first user equipment (UE), data using a first subset of the set of uplink shared channel occasions; and
receiving, after receiving the data using the first subset of the set of uplink shared channel occasions, a second control signal indicating that a second subset of the set of uplink shared channel occasions will be skipped for uplink data transmission by the first UE.

30. The method of claim 29, further comprising:
skipping decoding of the second subset of the set of uplink shared channel occasions based at least in part on receiving the second control signal within a first timing offset, the first timing offset measured from a temporally last uplink shared channel occasion of the set of uplink shared channel occasions and the first timing offset comprising a minimum time for the network entity to skip decoding of the second subset of the set of uplink shared channel occasions.
